(19) United States
(12) Patent Application Publication
(10) Pub. No.: US 2024/0276177 A1
(43) Pub. Date: Aug. 15, 2024

(54) Find My using Delegated Location

(71) Applicant: Apple Inc., Cupertino, CA (US)

(72) Inventors: Alexander R. Hanuska, Campbell, CA (US); Siva Ganesh Movva, San Jose, CA (US); Andrew I. Williams, Mountain View, CA (US); Sarish Jain, Mumbai (IN); Raghunandan K. Pai, Saratoga, CA (US); Swadesh Bhattacharya, Sunnyvale, CA (US)

(21) Appl. No.: 18/439,609

(22) Filed: Feb. 12, 2024

Related U.S. Application Data
(60) Provisional application No. 63/508,197, filed on Jun. 14, 2023.
(60) Provisional application No. 63/484,664, filed on Feb. 13, 2023.

(51) Int. Cl. H04W 4/029; H04L 9/08; H04L 9/40

(52) U.S. Cl. CPC H04W 4/029; H04L 9/0816; H04L 63/08

(57) ABSTRACT

Methods, non-transitory machine-readable mediums, and system to provide location services are described. In an embodiment, a method provides receiving, at a delegate server, authentication credentials from a sub-delegate of a delegate entity, determining at least one locator service for a wireless accessory device accessible to the sub-delegate with the received authentication credentials, receiving a request for the at least one locator service from the sub-delegate, evaluating a set of inputs to determine if a set of conditions corresponding to the at least one locator service and the sub-delegate are satisfied, upon determination that the set of conditions are satisfied, sending the request for the at least one locator service to a device locator server, and decrypting a response to the request received from the device locator server using encryption keys stored for the delegate entity.

This application claims the benefit of priority of U.S. Provisional Application No. 63/484,664, entitled “Find My using Delegated Location,” filed Feb. 13, 2023, and U.S. Provisional Application No. 63/508,197, entitled “Find My using Delegated Location,” filed Jun. 14, 2023, each of which is herein incorporated by reference.

### FIELD

Embodiments described herein relate to locating devices using device locator services.

### BACKGROUND INFORMATION

Previous device locator services generally provide locator services for a wireless device to an owner device and do not provide meaningful assistance in locating a device to an external entity to the device locator system. As such, there is a need to provide improved locator services.

### SUMMARY

Embodiments described herein provide for a system, a non-transitory machine-readable medium, and methods to provide location services. An embodiment provides receiving, at a delegate server from a delegate device, authentication credentials for a sub-delegate of a delegate entity, determining at least one locator service for an accessory device, the at least one locator service accessible to the delegate device with the received authentication credentials, receiving, from the delegate device, a request for the at least one locator service for the sub-delegate, evaluating a set of inputs to determine if a set of conditions corresponding to the at least one locator service and the delegate device are satisfied, upon determination that the set of conditions are satisfied, sending the request for the at least one locator service to a device locator server, and decrypting a response to the request received from the device locator server using one or more encryption keys stored for the delegate entity. Embodiments provide sending, to the delegate device, a set of locator services permitted with role of the subdelegate with the received authentication credentials. Embodiments further provide at least one condition from the set of conditions is that the sub-delegate is associated with the delegate entity, at least one condition from the set of conditions is that the accessory device status is not at least one of a near owner status or a near sharee status, near owner status includes the owner device in beacon signal range of the accessory device, and/or sending, to the delegate device, the response to the request, wherein the response is encrypted with a cryptographic key generated with a shared secret between the delegate device and a device paired with the accessory device.

Another embodiment provides determining, at an electronic device, a set of delegate keys for one or more privacy periods for the accessory device, the one or more privacy periods correspond to a defined period of time for a share of locator services with a delegate entity, sending, to a delegate server, a request to add the set of delegate keys to the share, sending, to the delegate server, metadata associated with a delegate entity, the metadata indicating an event with the delegate entity, and receiving location information for the accessory device and displaying the location information with the metadata associated with the delegate entity. Embodiments provide sending, to the delegate server, a set of conditions for the delegate entity to access to the set of locator services for the accessory device. Embodiments further provide sending, to the delegate server, a set of locator services accessible by sub-delegates of the delegate entity. Embodiments further provide the metadata includes a set of locator services for the accessory device and information on the defined period of time for the share of locator services. Embodiments further provide wherein the set of conditions are provided by the delegate entity. Embodiments further provide sending, to a delegate device, at least one shared secret to generate cryptographic keys. Embodiments further provide sending, to the delegate device, the set of delegate keys and the metadata. Embodiments further provide the delegate device and the electronic device communicate via near field communication, Bluetooth Low Energy, or other radio protocol. Embodiments further provide the electronic device is associated with an online account for an owner device paired to the accessory device. Embodiments further provide the electronic device is selected from a set of electronic devices associated with trusted online accounts, wherein the trusted online accounts received shared secrets from an owner device to generate delegate keys, wherein the owner device is paired to the accessory device.

Another embodiment provides sending, to a delegate server, authentication credentials for a sub-delegate of a delegate entity and information on at least one condition for accessing location services for an accessory device, receiving information on a set of location services accessible for the authentication credentials satisfying the at least one condition, sending, to a delegate server, a request for locator services for the accessory device, and receiving an encrypted response for the request. Embodiments further provide receiving, from an electronic device, a set of delegate keys and metadata, the metadata indicating an event with the delegate entity. Embodiments further provide receiving, from an electronic device, a delegate shared secret, and decrypting the encrypted response with decryption keys generated in part using the delegate shared secret. Embodiments further provide the at least one condition for accessing location services is determined based on the sub-delegate role at the delegate entity. Embodiments further provide satisfying the at least one condition by sending, to the delegate server, location information for the delegate device, and receiving an indication that the delegate device with the authenticated credentials for the sub-delegate role is located in at least one delegate entity location authorized for the request. Embodiments further provide detecting, from the accessory device, a beacon signal, and transmitting location information for the accessory device to at least one of an owner device or a location server. Embodiments further provide the location information is encrypted using encryption keys generated using at least a shared secret between the delegate device and a device paired with the accessory device.

Yet, another embodiment provides receiving, at a delegate device, a share resource locator to access a location service for an accessory device, the share resource locator comprising a portion of the share resource locator accessible within an application on the delegate device, and the portion of the share resource locator comprising a cryptographic key, sending, to a device locator server, a request to access the location service with the share resource locator via the application, and decrypting a response to the request, from the device locator server, with the cryptographic key within the application. Embodiments further provide the share resource locator is a uniform resource locator and the portion of the uniform resource locator comprises an anchor link. Embodiments further provide the application is a third party application and the portion of the share resource locator is stored at a third party server.

Another embodiment provides receiving a share resource locator request to access a location service for an accessory device, receiving, from a delegate device, authentication credentials, evaluating metadata to determine if conditions are satisfied for a share with an authenticated user of the delegate device, and upon a determination that a set of conditions are satisfied for a share, sending a response to the delegate device for the location service. Embodiments further provide the metadata includes an access policy and a rate-limit policy for the delegate entity. Embodiments further provide applying a hash function to an identifier to produce a hash result for the identifier, and comparing the hash result to a set of hash results associated with the share resource locator to determine if a rate limit threshold for the share is exceeded. Embodiments further provide evaluating metadata to determine if conditions satisfied by determining if the owner device is in beacon signal range of the accessory device. Embodiments further provide evaluating metadata to determine if conditions satisfied by determining if the delegate device associated with a delegate entity designated the accessory device as near an owner device. Embodiments further provide receiving, at a third-party server, a share resource locator request via a third party application to access a location service for the accessory device.

### BRIEF DESCRIPTION OF THE DRAWINGS

FIG. 1 is a block diagram of a network operating environment for electronic devices, according to an embodiment.

FIG. 2 illustrates a system to locate a wireless accessory device, according to an embodiment.

FIG. 3 illustrates a system for pairing and locating a wireless accessory, according to an embodiment.

FIG. 4 is a flow diagram illustrating a method for use with device locator systems, according to an embodiment.

FIG. 5 is a network operating environment for electronic devices, according to an embodiment.

FIG. 6 is a flow diagram illustrating a method for use with device locator systems, according to an embodiment.

FIG. 7 is a flow diagram illustrating a method for use with device locator systems, according to an embodiment.

FIG. 8 is an operating environment for electronic devices, according to an embodiment.

FIGS. 9A-12E illustrate delegation user interfaces, according to some embodiments.

FIG. 13-14 illustrate flowcharts for methods that can be performed by a finder device, according to embodiments.

FIG. 15 is a flow diagram illustrating a method of broadcasting a signal beacon at a wireless accessory, according to an embodiment.

FIGS. 16-17 illustrate delegation user interfaces, according to some embodiments.

FIG. 18 is a block diagram illustrating an exemplary API architecture, which may be used in some embodiments.

FIG. 19 is a block diagram of a device architecture for a mobile or embedded device, according to an embodiment.

FIG. 20 is a block diagram of a computing system, according to an embodiment.

FIG. 21 is a flow diagram illustrating a method for use with device locator systems, according to an embodiment.

FIGS. 22-23 illustrate delegation user interfaces, according to some embodiments.

FIGS. 24A-24B illustrate delegation user interfaces, according to some embodiments.

### DETAILED DESCRIPTION

Embodiments described herein generally provide techniques for delegation of locator services for an accessory device to a delegate entity by a device owner. In some embodiments, the techniques are for delegation of locator services for the accessory device by a device owner to an external entity. Techniques are described for sharing locator services for the accessory device by a device owner to with a rate limited set of users in some embodiments, including users that are affiliated or unaffiliated withs a delegate entity. By rate limiting the number of users with delegated locator services by the device owner, device locator services may be shared without impacting the performance of locator services. The device owner may have a mobile device that is paired to the accessory device, such as a locator tag, and the device owner may have a set of locator services provided upon request via a device locator server. The locator services allow the device owner to track and locate the accessory device. The device owner registers the external entity as a delegate entity with a delegate server and the device owner may select a subset of device locator services delegated to the external entity for a defined period of time. By registering the external entity as a delegate entity, the sub-delegates of the delegate entity may have an entitlement to access locator services provided other conditions are met for the sub-delegate.

The external entity is an entity that is a third party to the device locator service provider and the device owner. For example, the external entity may be an airline or other service that is entrusted with an item associated with the accessory device or otherwise obliged to provide services to the device owner in regard to the accessory device itself and/or the item associated with the accessory device. In another example, the item may be luggage with the accessory device, such as a locator tag, attached to the luggage and the external entity airline may be obliged to transport the luggage for the device owner during a scheduled flight. Alternatively, the item may be the accessory device, such as Apple AirPods, that may have been left on an airplane of the external entity during a scheduled flight.

The device owner may select the external entity to serve as a delegate entity for the defined period of time and the device owner may grant the delegate entity access to a subset of device locator services for the accessory device to enable the delegate entity to track and locate the accessory device. In some embodiments, metadata on the owner device related to an event with the delegate entity may be used to automatically establish the defined period of time that the external serves as a delegate entity and/or automatically select the subset of device locator services accessible to the delegate entity. For example, metadata on-device of the device owner for a scheduled flight event with an airline carrier selected as the delegate entity, such as a boarding pass or calendar data for the scheduled flight, may be used to determine the defined period of time and the set of locator services to allow the airline carrier to access.

The delegate entity may have sub-delegates (e.g., a set of employees/agents with employee/agent roles) using delegate devices that are permitted to use the subset of locator services delegated to the delegate entity. The employee of the delegate entity may use the delegate device to authenticate with a delegate server. The delegate server may ensure that the delegate device satisfies a set of conditions in order to access each device locator service and will service the device locator requests via requests to the device locator server on behalf of the delegate entity. In some embodiments, the delegate server may have a set of identifiers for sub-delegates or delegate devices that are associated with the delegate entity. The sub-delegate and/or delegate device may need to send credentials to the delegate server to be authenticated. The delegate server may ensure that a connection or relationship between the sub-delegate and the delegate entity is maintained by eliminating sub-delegates that no longer have a relationship with the delegate entity.

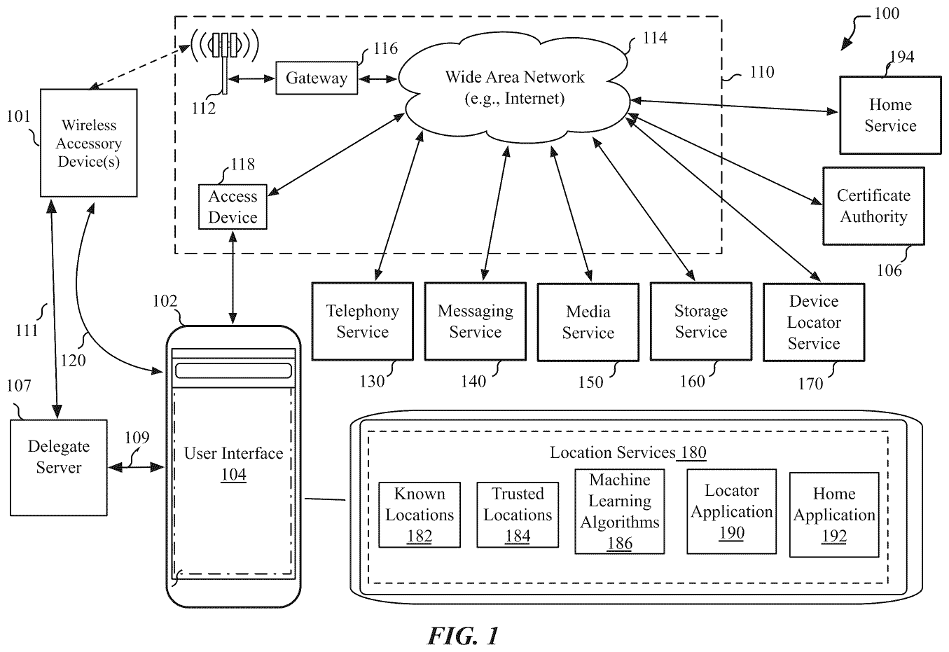

In some embodiments, delegate server may serve as a key escrow with a set of keys for the delegate entity that are held for the duration of the defined period of time and the delegate server may upon request encrypt data sent to the device locator server or decrypt data sent from the device locator server when the requesting delegate device and/or sub-delegates satisfies a set of conditions. Because the delegate server is serving as a key escrow, the location data for the accessory device is opaque to both the device locator service provider and the delegate entity. FIG. 1 is a block diagram of a network operating environment 100 for electronic devices, according to an embodiment. The network operating environment 100 includes multiple electronic devices, such as accessory device(s) 101, a delegate server 107, and a mobile device 102. Accessory device(s) 101 may be paired to mobile device 102. In an embodiment, the accessory device may itself be a tracking device, such as an Apple AirTag®.

In another embodiment, mobile accessory device 101 may be a single device or a set of accessory devices. For example, the mobile accessory device 101 may be a smartphone or Apple AirPods® which includes a set of accessory devices that form a device group (e.g., left AirPod, right AirPod, AirPod case, etc.) that have been lost en route with an airline external entity. Although examples may be provided throughout that describe the mobile accessory device 101 as a locator tag, those with skill in the art will recognize that the mobile accessory device 101 may be a second owner device, such as a laptop computer, a smartphone, a tablet computer, a wearable computer (e.g., a smartwatch), and/or any other mobile device. The accessory device 101 may be a device that is associated with the same user account as the owner device 102 and the owner device 102 may be used to delegate locator services for the accessory device 101 to the external entity. In another example, a set of accessory devices may be paired to the mobile device 102 and the set of accessory devices may form the device group. Optionally, the device group with accessory devices 101 may be a case with a wired connection to the accessory devices 101 stored within. The case itself may also be an accessory device 101 that may be paired with mobile device 102 in some embodiments. By way of example, accessory device 101 may be collectively sets of devices, such as Apple AirPods® or EarPods®.

In some embodiments, accessory device 101 may not be able to communicate over a wide area network. In other embodiments, devices 101, 102, and 107 can each be an electronic device capable of communicating over a wireless network. Some example mobile electronic devices include but are not limited to the following: a smartphone, a tablet computer, a notebook computer, a wearable computer (e.g., smartwatch or other wearable computing accessory), a mobile media player, a personal digital assistant, AirPods®, EarPods®, AirTag®, locator tags, headphones, head mounted display, health equipment, a speaker, and other similar devices.

Delegate server 107 may be implemented as a set of one or more servers servicing requests from mobile device 102 and delegate devices of the delegate entity. The device owner may use mobile device 102 to select the external entity as the delegate entity and create a share record for the external entity stored in a share database with the delegate server 107. The mobile device 102 generates a set of keys expected to be used for the duration of the defined period of time that the external entity serves as the delegate entity. In an embodiment, the delegate server 107 is a key escrow that holds the keys necessary to decrypt and encrypt data sent between the delegate server and the device locator server. Electronic devices 102 and delegate entity devices may use an application programming interface to access delegate locator services.

Electronic devices 101, 102 and 107 can communicate over one or more wired and/or wireless networks 110 to perform data communication. For example, a wireless network 112 (e.g., cellular network, Wi-Fi network) can communicate with a wide area network 114, such as the Internet, by use of a gateway 116. Likewise, an access device 118, such as a mobile hotspot wireless access device, can provide communication access to the wide area network 114. The gateway 116 and access device 118 can then communicate with the wide area network 114 over a combination of wired and/or wireless networks.

In some implementations, both voice and data communications can be established over the wireless network 112 and/or the access device 118. For example, mobile device 102 can place and receive phone calls (e.g., using VoIP protocols), send and receive e-mail messages (e.g., using POP3 protocol), and retrieve electronic documents and/or streams, such as web pages, photographs, and videos, over the wireless network 112, gateway 116, and wide area network 114 (e.g., using TCP/IP or UDP protocols). In some implementations, mobile device 102 can place and receive phone calls, send and receive e-mail messages, and retrieve electronic documents over the access device 118 and the wide area network 114. In some implementations, mobile device 101 and/or mobile device 102 can be physically connected to the access device 118 using one or more cables, for example, where the access device 118 is a personal computer. In this configuration, mobile device 101 or mobile device 102 can be referred to as a “tethered” device. In one embodiment, mobile device 101 can communicate with mobile device 102 and/or smart home device via a wireless peer-to-peer connection 120. The wireless peer-to-peer connection 120 can be used to synchronize data between the devices.

Electronic devices 101, 102, and 107 can communicate with one or more services, such as a telephony service 130, a messaging service 140, a media service 150, a storage service 160, a device locator service 170, certificate authority 106, and home service 194 over the one or more wired and/or wireless networks 110. For example, the telephony service 130 can enable telephonic communication between mobile devices or between a mobile device and a wired telephonic device. The telephony service 130 can route voice over IP (VOIP) calls over the wide area network 114 or can access a cellular voice network (e.g., wireless network 112). The messaging service 140 can, for example, provide e-mail and/or other messaging services. The media service 150 can, for example, provide access to media files, such as song files, audio books, movie files, video clips, and other media data. The storage service 160 can provide network storage capabilities to mobile device 101 and mobile device 102 to store documents and media files. The device locator service 170 can enable a user to locate a lost or misplaced device. The home service 194 can enable a user to manage smart home devices with the user of a home application 192. Other services can also be provided, including a software update service to update operating system software or client software on the mobile devices. In one embodiment, the messaging service 140, media service 150, storage service 160, the home service 194, and device locator service 170 can each be associated with a cloud service provider, where the various services are facilitated via a cloud services account associated with the electronic devices 101, 102, and 107.

In some embodiments, accessory device 101 and/or device group 101 and mobile device 102 may be registered with a certificate authority 106. In some embodiments, the certificate authority 106 is an entity that issues digital certificates, and the service may be implemented using a set of servers managed by a device manufacturer, service provider, or a registration service. The certificate provided by the certificate authority 106 may attest to the validity of received verifiable information about the device, such as a particular manufacturer for the device, a serial number, an identifier for a device group or other identifier, an indicator that device is part of a device group, and/or any other verifiable information. In some embodiments, a device manufacturer may establish the device group by grouping serial numbers of accessory devices in the device group. In further embodiments, the certificate can be encrypted by the device 101 and/or 102 prior to being sent to a third party and may be decrypted at an attestation service (e.g., certificate authority or another attestation service) when the third-party requests verification of information provided by accessory device 101, mobile device 102, smart home device, and/or devices within device group. In some embodiments, a secure token may be provided in requests to pair by an accessory device 101. Additional examples of paired devices using location services may be found in U.S. patent application Ser. No. 17/219,595, filed Mar. 21, 2021, entitled “Secure Pairing and Pairing Lock for Accessory Devices,” which is incorporated by reference herein in its entirety.

Electronic devices 101 and 102 may have applications, services, and functionality locally accessible on the devices. In particular, mobile devices 101, and/or 102 may have a device locator application (e.g., a “Find my” application) 190 to utilize device locator services 170 and location services 180. Locally accessible data may be stored on known locations 182 and safe or trusted locations 184. In some instances, machine learning algorithms 186 may be used to identify user routines, known locations 182, and/or trusted locations 184. Although cluster analysis is provided as an example of machine learning algorithms that may be used, those with skill in the art will recognize that other algorithms may be used to identify potential known or trusted locations. By way of example, cluster data analysis may be used to identify and classify and provide semantic labels for locations or defined spaces, such as locations frequented by a user. Safe or trusted locations 184 may be designated explicitly or confirmed as such by a user of the mobile device 102 after data analysis. Additionally, user routines may be defined explicitly by a user of the mobile device 102. In other instances, the known locations 182, the trusted locations 184, and user routines may be classified offline and provided by device locator service 170, a home application or service, or a third-party (e.g., a database with map information, a home hub device, etc.).

On-device heuristics and/or machine learning models may be used to infer relationships between a user and locations (e.g., including defined spaces) based on analysis of the locally stored data on frequented locations including frequently visited locations by the user, known locations, routines, and/or any other locations. For example, a frequently visited location such as a home, a vehicle, a workplace, any location frequented by a user with mobile device (e.g., accessory devices, 101 and mobile device 102) and/or any other location designated as a trusted location 184 by the user. Known locations 182 may be business locations, public spaces, parks, museums, front yard, back yard, and/or any other location that may be frequented by a user. Boundary information for the respective stored locations may be stored along with classification type for the location and any semantic label assigned to the location. Stored information may include a defined set of boundaries or a radius distance around a point location to allow for creation of a geofence for the location. The geofence is a virtual perimeter for a real-world geographic area. Global positioning system (GPS) may be used to create a virtual fence around a location and track the physical location of the electronic devices 101 and 102 within the geofence boundary as well as entry and exit of the bounded area.

Machine learning algorithms 186 may include on-device heuristics, machine learning algorithms, or a combination thereof to analyze and assign a label regarding movement or travel of a device to be designated as being “in transit” state, “moving” state, or “settled” state in a defined space for a time period. Analysis may be performed using a variety of signals from data sources available to the mobile device 102, including, but not limited to, the following: sensor data, positioning data, calendar data, transit card usage data, application data, historical data on patterns/routines of travel, and/or any other data accessible to the mobile device 102. In some embodiments, a mobile device 102 may be classified with a “settled” semantic label after remaining within the geographic boundaries that define a location (e.g., the trusted location 184) for a defined time period. Positioning data for the mobile device 102 may remain within the boundaries of a geofence for a particular location for a duration of time (e.g., 5 minutes). Sensor data, such as accelerometer data, may indicate that the mobile device 102 is at rest to support an inference of being settled.

Application data may support the inference that the mobile device 102 is settled, such as the mobile device being located at a calendar appointment location. Application data indicating a type of application in use may also provide an inference of the device being settled, such as using a media application and/or a smart home device. Historical data for the user on routines or patterns in travel may be used to determine whether the mobile device 102 is settled in a defined space, such as a bedtime routine at a home or hotel location. Mobile device 102 may be classified as with an “in transit” label based on prior behavior, patterns, or routines for the user and analyzed on mobile device 102. For example, the user may have routine of going to work around the same time every day and an “in transit” state may be assigned if the data on the device supports that the pattern is being repeated. In another example, a speed at which the mobile device is moving or entering and exiting known geographic areas (e.g., using geofences) may allow for the inferring that the mobile device 102 is in transit. If the mobile device 102 is detected as accelerating in known areas of transit (e.g., on roads, highways, train routes, etc.), then the mobile device 102 may be given the status of “in transit.” Similarly, if transit applications/cards are used/in use, then the mobile device 102 may be designated as “in transit”.

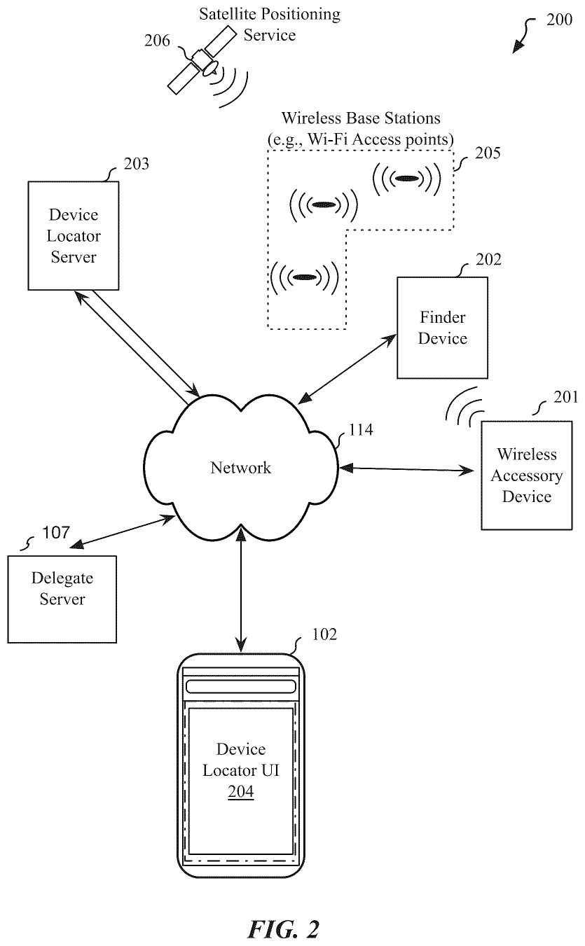

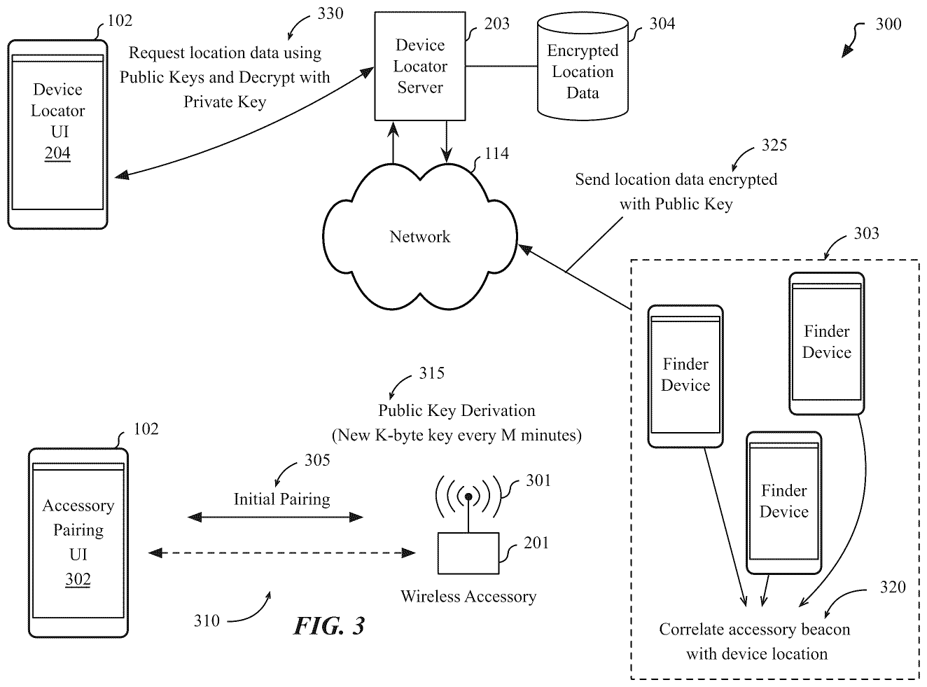

FIG. 2 illustrates a system 200 to locate a wireless accessory device 201, according to an embodiment. Wireless accessory device 201 may be an accessory device 101 as described with reference to FIG. 1. In one embodiment, the wireless accessory device(s) 201 is a locator tag associated with an item, such as luggage, and the accessory device 201 is paired to mobile device 102. Each accessory device 201 includes one or more wireless transceivers and can communicate, either directly or indirectly (e.g., through another device or computer) with a companion device (e.g., mobile device 102) over a wireless network or peer-to-peer communication link. Accessory device(s) 201 may provide a beacon signal for one or more accessory devices and/or each accessory device 201 may be independently and separately capable of being found by each providing the beacon signal. Some examples of wireless accessory devices 201 include, but are not limited to, the following: wireless earbuds, EarPods, Apple AirPods, input devices, a charging device, a case for accessories, headphones, headsets, fitness equipment, health equipment, display devices, external hard drives, other wearable devices (e.g., smartwatches, fitness bands, optical head-mounted displays) adapters, speakers, device locator tags, and/or any other mobile devices. Paired groups of accessories may be the same type of device (e.g., speakers, AirPods, fitness weights, etc.) or different types of devices (e.g., smartphone and credit card reader, etc.).

The wireless accessory device 201 can also include other wireless devices such as input devices including, but not limited to credit card reading devices, stylus devices, mouse, keyboard, game controllers and/or remote controls. The wireless accessory 201, in one embodiment, also includes smartphones, tablet computers, laptop computers, smart speaker devices, televisions, or television set top boxes that at least temporarily are unable to access a wide area network, such as the Internet (e.g., wide area network 114 as in FIG. 1). The wireless accessory 201 can also be any other wireless device, including beacons or locator tags that can be attached to other devices to enable the tracking or locating of those devices. In one embodiment, the wireless accessory 201 can be from a device group of accessory devices that are paired with the mobile device 102 using a wireless technology standard, such as but not limited to Bluetooth. The wireless accessory 201 can also communicate with the mobile device 102 and/or delegate devices over wireless technologies including the implementation of any wireless standards and protocols, such as Wi-Fi direct, Zigbee, or AirPlay. While the companion device to which the wireless accessories 201 are paired is generally referred to as a mobile device 102, companion devices are not limited to mobile devices. Companion devices, in some embodiments, can also include laptop or desktop devices and can additionally include some wearable accessories, such as but not limited to a smart watch device or a wearable display.

In one embodiment, the wireless accessory 201 can periodically transmit a wireless beacon signal. The wireless accessory 201 can transmit the beacon signal using one of a variety of wireless technologies described herein (e.g., Bluetooth, Wi-Fi, etc.) and in one embodiment can also beacon using an ultra-wide band (UWB) radio technology. The beacon signal can be transmitted using a single wireless technology, one of multiple selectable wireless technologies, or multiple simultaneous wireless technologies. The beacon signal can transmit a beacon identifier that includes information to specifically identify the individual wireless accessory 201, and/or a device group. In one embodiment, the beacon identifier is a public encryption key associated with the device.

The beacon signal can also convey information about the wireless accessory 201, such device status information and/or verifiable information. Device status information in the beacon signal may include, but is not limited to the following: a beacon type, a device classification, a battery level, any pre-defined device status, a device state, a lost status, an alarm status, a separated from owner status, a near-owner status, a proximate to one or more accessory devices in a device group status, a wired or wireless connection status, a physically connected to one or more accessory devices in a device group status, a pairing status indicating whether accessory device is paired or not paired, a pending pairing status, a battery life state, a charging status, a near-smart home device status, a near sharee device status, a near external entity establishment status, and/or any other status information. The near-owner status can indicate that the wireless accessory 201 has detected the nearby presence of the mobile device 102 associated with the owner of the accessory. The lost or “separated from owner” status can indicate that the wireless accessory 201 has determined itself to be lost or has been placed into a lost state by the owner of the device. The alarm status can indicate that the wireless accessory 201 was placed in a state that the wireless accessory device 201 should trigger an alarm if moved from a current location. The near-smart home device status may indicate that the wireless accessory device 201 is in communication with smart home device for the owner device and/or a finder device. The near sharee device status may indicate that the wireless accessory device 201 is in communication with a recipient (e.g., sharee) of a share of keys from the wireless accessory device 201 owner. A sharee is a recipient of a share of keys for the wireless accessory device. The sharee may be a user that the owner (or another sharee) has entrusted with location services directly and/or a sub delegate of a delegate entity. The share of keys permits the sharee to use specific location services and/or create a share of keys for the wireless accessory device, if the wireless accessory device 201 owner has established that the sharee may share keys to another recipient. The near external entity establishment status may indicate that the wireless accessory device 201 is located near an establishment of the external entity, such as an airline check-in desk or a baggage storage facility.

In some embodiments, verifiable information may include any information that may be needed to establish trust or authority that a pairing process, a setup process, a device discovery process, and/or a finding process may proceed with the device presenting the verifiable information. By way of example, verifiable information may include information established by a device manufacturer, such as a serial number or a set of serial numbers in a device group or a smart home device. In some embodiments, the verifiable information may include status or state information for the device. The verifiable information may include, but is not limited to, the following: a device type, a member of device group, a serial number, a device group, serial numbers of other devices within a device group, state or status information, a software version, and/or any other verifiable information. Verifiable information may be sent to the certificate authority 106 or other attestations service to verify received information presented by the device to another device. Verifiable information may be encrypted and/or sent with a token to allow for further verification of the device.

In some embodiments, the beacon signal can be detected by a finder device 202, which is locally proximate to the wireless accessory 201 in order to use crowdsourcing to locate a lost wireless accessory 201. In further embodiments, the delegate device may provide additional functionality as a finder device 202. The finder device 202 can be a similar device as the mobile device 102 and can receive and transmit data over a wide area network 114 and receiving and transmitting using similar wireless technologies as the wireless accessory 201 (e.g., Bluetooth, etc.). Particularly, the finder device 202 can receive data using the wireless protocol over which the beacon signal is transmitted. The finder device 202 can determine a location using one or more location and/or positioning services including, but not limited to a satellite positioning service 206 or a terrestrial positioning system using RF signals received from wireless base stations 205 such as Wi-Fi access points or cell tower transmitters of a cellular telephone network. In an embodiment, the finder device 202 periodically stores its location as determined based on the one or more location and/or positioning services. The stored location can be associated with a timestamp for which the location was determined. When the finder device 202 receives a beacon signal from the wireless accessory 201, the finder device 202 can transmit a location for the finder device 202 over the wide area network 114 to a device locator server 203. The timestamp for a determined location for the finder device 202 can be correlated with a timestamp for which a beacon signal was received to associate a geographic location with a received beacon signal.

Where the wireless accessory 201 provides a public key within the beacon signal, the finder device 202 can encrypt the determined location data and transmit the encrypted location data to the device locator server 203 over the wide area network 114. In one embodiment, additional data can either be encrypted and transmitted along with the location data or transmitted unencrypted to the device locator server 203. For example, the RSSI for the beacon signal can be transmitted along with the location data. The RSSI data can then be used to determine the distance of the wireless accessory 201 from the finder device 202 and assist in triangulation on the owner device. Where the RSSI data is transmitted in an unencrypted state, in one embodiment the server can use RSSI information to reduce noise by discarding very weak signals if other, stronger signals are present. In one embodiment, UWB ranging data can also be provided, where such data is available.

In some embodiments, the beacon signal from the wireless accessory 201 can be detected by a delegate device, a variant of finder device 202. A mobile device 102 may send a request via delegate server 107 to perform a beacon scan to determine if the delegate device can detect a beacon signal sent from a wireless accessory device 201. Alternatively, the mobile device 102 may directly communicate with the delegate device. In some embodiments, the mobile device 102 may authorize sending a data packet with the request that contains one or more public keys to identify advertisements from the wireless accessory device 201. If the delegate device detects the beacon signal from the wireless accessory device 201, then the delegate device may communicate that the beacon signal was received via the delegate server 107 to the mobile device 102. For example, if the beacon signal from the wireless accessory device 201 includes an advertisement with a key from the one or more public keys sent by the mobile device 102, then the delegate server 107 may respond to the request by sending location information (e.g., ranging data, signal strength information, etc.) for the wireless accessory device 201 to the mobile device 102 and/or the device locator server 203.

In one embodiment, location information for the wireless accessory device 201 received from the delegate device 107 can either be encrypted or transmitted unencrypted to the mobile device 102 and/or device locator server 203. A received signal strength indicator (RSSI) for the beacon signal can be transmitted along with the location data for the wireless accessory device 201 to the mobile device 102. The RSSI data can then be used to determine the distance of the wireless accessory 201 from the delegate device and assist in triangulation on the mobile device 102. The location information provided to the mobile device 102 may include information on the location of the wireless accessory 201 within the location environment. Where the RSSI data is transmitted in an unencrypted state, in one embodiment, the device locator server 203 and/or the mobile device 102 can use RSSI information to reduce noise by discarding very weak signals if other, stronger signals are present from other devices.

In one embodiment, the finder device 202 can behave differently upon receiving a beacon signal from a wireless accessory 201 depending upon a device status conveyed by the wireless accessory 201. For standard beacon signals, the finder device 202 can place encrypted location data into a queue and transmit the location data to the device locator server 203 during a periodic transmission window. However, if the wireless accessory 201 is indicating an alarm state, the finder device 202 can transmit the location data to the device locator server 203 immediately. In the case of the smart home device receiving an indication that the wireless accessory device 201 is in the alarm state, the smart home device may immediately play media files on behalf of the wireless accessory device 201. Additionally, the finder device 202 may not transmit the location data to the device locator server 203 if the beacon signal of the wireless accessory 201 indicates that the accessory is near the owner of the accessory. Alternatively, the finder device 202 may delay transmission of encrypted location data.

If the owner of the wireless accessory 201 wishes to locate the wireless accessory device 201, the owner can access a device locator user interface (UI) 204 on the mobile device 102. The device locator UI 204 can be associated with a device locator application that is used to locate electronic devices and accessories that are registered with an online account of the user, such as a cloud services account or another type of online account. The device owner, using the device locator UI 204, can query the device locator server 203 for location data that may have been transmitted to the device locator server by a finder device 202 of the wireless accessory 201. In one embodiment, the mobile device 102 can transmit the public encryption key associated with the wireless accessory 201 to the device locator server 203. The device locator server 203 can then return any stored location data that corresponds with the public encryption key. The location data returned to the mobile device 102 can be encrypted data that is encrypted by the finder device 202 using the public encryption key. The mobile device 102 can use an associated private key to decrypt the encrypted location data. The decrypted location data can then be processed by the mobile device 102 to determine a most probable location for the wireless accessory 201. In various embodiments, the most probable location for the wireless accessory 201 can be determined by triangulation from multiple received locations and using other data, such as a beacon signal RSSI associated with each location and timestamp or UWB ranging data included within the location data.

FIG. 3 illustrates a system 300 for pairing and locating a wireless accessory device, according to embodiments described herein. In one embodiment a mobile device 102 of a user of the wireless accessory 201 (e.g., example of device 101) can present an accessory pairing UI 302 by which the user can pair the mobile device 102 with the wireless accessory 201. During an initial pairing (305) between the mobile device 102 and the wireless accessory 201, a public key exchange (310) can be performed between the mobile device 102 and the wireless accessory 201. In one embodiment, during the public key exchange (310) the mobile device 102 and the wireless accessory 201 exchange public keys of public key pairs generated by the device and the accessory 201. In one embodiment the public key exchange (310) is a one-way transfer, in which the mobile device 102 transmits a public key of a public/private key pair to the wireless accessory 201. Alternatively, or additionally, the public key exchange (310) may be a Diffie-Hellman key exchange in which the device and the accessory establish a shared secret between two parties. In one embodiment, the public key exchange (310) additionally uses elliptic curve cryptography to establish the shared secret. For example, Elliptic-curve Diffie-Hellman (ECDH) can be used to enable the establishment of a public key pair and one or more shared secrets. In one embodiment, the one or more shared secrets include an anti-tracking secret, which can be used by the wireless accessory 201 to periodically derive additional public keys.

After the wireless accessory 201 has been paired with the mobile device 102, the wireless accessory 201 can periodically broadcast a beacon signal 301 that includes device status information and a beacon identifier. In one embodiment, the beacon identifier is a public key derived from a shared secret that is established during the public key exchange (310). Additionally, the wireless accessory 201 can periodically perform a public key derivation (315) to generate a new public key and begin broadcasting the new public key as the beacon identifier. The public key is a K-byte key, with a new K-byte key generated every M minutes. The value K and M can vary between embodiments. In one embodiment, a K value of 28 bytes is used. In one embodiment, a K value of 27 bytes is used. The value K can be determined at least in part based on the beacon length associated with the wireless protocol used to transmit the beacon signal 301. In one embodiment, the beacon signal can transmit a variant of beacon advertisement packet associated with a low-energy radio protocol, such as Bluetooth Low Energy.

The value M, in one embodiment, is 15 minutes, such that a new K-byte key is generated every 15 minutes. The public key can be derived deterministically based on a timestamp and an anti-tracking secret generated during the public key exchange 310. The public key derivation (315) process enables the wireless accessory 201 to use different keys over time, preventing the long-term association with a specific key with a specific device. The key can be derived based on an anti-tracking secret known only to the mobile device 102 and the wireless accessory 201, allowing the mobile device 102, and only the mobile device, to determine which public key will be broadcast by the wireless accessory 201 at any given timestamp. The anti-tracking secret can be generated along with an ECDH public key and transferred to the wireless accessory 201. The anti-tracking secret can then be used to enable the wireless accessory 201 to generate a sequence of public keys Pᵢ. In one embodiment, the sequence of public keys Pᵢ=λᵢ·P, which defines a group operation between a scalar or exponent value λᵢ and group elements, such as, for example, Elliptic Curve points P. The scalar or exponent value λ=KDF(AT, i), where KDF is a key derivation function, AT is the anti-tracking secret, and i is a counter or timestamp.

In one embodiment, backtracking resistance can be enabled to protect the anti-tracking secret in the event the wireless accessory 201 is compromised. When backtracking resistance is enabled, the anti-tracking secret is transferred to the wireless accessory 201 but is not retained by the wireless accessory. Instead, the accessory computes a value λᵢ₊₁=H(λᵢ∥time), with λ₀=AT and H being a cryptographic hash function. The wireless accessory 201 then stores λᵢ for a given time period i. If the wireless accessory 201 is compromised, only λᵢ for current and future values of i is exposed, without exposing the anti-tracking secret AT. In one embodiment, backtracking resistance is performed by periodically writing λᵢ to non-volatile memory of the wireless accessory 201.

In one embodiment the wireless accessory 201 can transmit the beacon signal 301 every two seconds, although other beacon rates can be used, and the beacon rate can vary under certain circumstances. For example, the wireless accessory 201 can decrease a beacon rate when in a near-owner state. Beacon rate can also vary based on accelerometer triggered events. For example, the wireless accessory 201 can increase the beacon rate when in an alarm state, which can be triggered by the accelerometer on the wireless accessory 201.

The wireless accessory 201 can enter the near-owner state if, after transmitting the beacon signal 301, the wireless accessory 201 receives a reply from the mobile device 102 associated with the user of the accessory, which indicates that the mobile device 102 is within range of the wireless accessory. Additionally, while the wireless accessory is in the near-owner state, the amount of data transmitted by the beacon signal 301 may be reduced. In one embodiment, the rate at which new public keys are generated can also be reduced while the wireless accessory is in the near-owner state.

The wireless accessory 201 can enter an alarm state upon receiving a message from the mobile device 102 that indicates that the wireless accessory 201 should enter the alarm state. When in the alarm state, the wireless accessory can initially enter an armed state in which the wireless accessory 201 can reduce or cease the transmission of locator beacon signals, although other types of wireless signaling can persist. The wireless accessory 201 can remain in the armed state until the state is deactivated by the mobile device 102 or alarm is triggered. The alarm can be triggered, in one embodiment, upon detection of movement, for example, via an accelerometer within the wireless accessory 201. The alarm can also be triggered, in one embodiment, upon detection that the wireless accessory 201 has moved out of range of the mobile device 102 and is no longer in the near-owner state. When the alarm is triggered, the rate at which the beacon signal 301 can be increased, to increase the speed by which the wireless accessory 201 can be located.

The beacon signal 301 transmitted by the wireless accessory 201 can be detected by a set of finder devices 303 (finder devices may be finder device 202) and/or the mobile device 102, which are other electronic devices that can receive the beacon signal transmitted by the wireless accessory and are transmit location and other data associated with the beacon signal 301 to the device locator server 203 via the wide area network 114. In one embodiment the set of finder devices 303 include variants of the mobile device 102 or can be other types of electronic devices. For example, the set of finder devices 303 can perform operations (320) to correlate the beacon signal 301 received from the wireless accessory 201 with a device location associated with the finder device 303. As described with respect to FIG. 2, the device location can be determined via a satellite positioning service or a terrestrial positioning system that uses RF signals received from wireless base stations (e.g., Wi-Fi access points or cell tower transmitters). In one embodiment the set of finder devices 303 can also include stationary devices such as smart speaker devices, televisions, or television set top boxes that can receive the beacon signal 301.

The set of finder devices 303 can encrypt the location data with the beacon identifier (e.g., public key) received within the beacon signal 301 and send the location data (325) to the device locator server 203. The data sent by the set of finder devices 303 is send anonymously and no identifying information for the finder devices is stored with the data sent by the finder devices.

The device locator server 203 can store encrypted location data in a data store 304, which in one embodiment can be a distributed database having multiple nodes. Hashes of the beacon identifier/public key of an accessory can be sent along with encrypted location data. The encrypted location data can be stored to a database node based on a hash of the beacon identifier. The encrypted location data can be indexed by the device locator server 203 using the hash of the beacon identifier. Sending the hash of the beacon identifier instead of the full beacon identifier prevents the storage of the full beacon identifier to the server. Other information can also be sent and stored with the location data, either in an encrypted or unencrypted state. The other information can include timestamps for when the beacon signal 301 was received, RSSI information for the received beacon, and/or ranging information determined, for example, via UWB ranging.

When the user or owner of the wireless accessory 201 wishes to locate the accessory, the user or owner can access the device locator UI 204 on the mobile device 102. The device locator UI 204 can be associated with a locator application 190 or feature of the mobile device 102. The device locator UI 204 may also have a web-based interface that can be accessed from the mobile device 102 or another type of electronic device, such as a laptop or desktop device. The mobile device 102, upon loading the device locator UI 204, can send a request (330) for location data to the device locator server 203. The request 330 can include a set of public keys or public key hashes, which can serve as beacon identifiers for the beacon data. The mobile device 102 can generate the set of public keys based on the secret information held by the mobile device 102 and the wireless accessory 201 and the timestamps over which the mobile device 102 wishes to receive location data. In one embodiment the set of public keys is the sequence of public keys Pᵢ that are generated based on the anti-tracking secret. The sequence of public keys Pᵢ corresponds to a matching sequence of private keys dᵢ. The mobile device 102 can generate the sequence of public keys, as well as the corresponding sequence of public keys dᵢ, where i is a counter or timestamp. In one embodiment, the mobile device 102 can generate and send the previous 24 hours of public keys (or hashes of the 24 hours of public keys) within the request 330. If no data is found for 24 hours of public keys, the mobile device 102 can send generate keys for an earlier period, back to a pre-determined location data retention limit.

In one embodiment the encrypted location data is stored and indexed based on a hash of the public key instead of the public key to prevent the provider of the location service data from storing data that can be used to tie the encrypted location data to a specific device, and thus a specific user or user account. The finder device can send the hash of the public key that is broadcast within the beacon signal 301 associated with an observation location. The owner of the device can query the device locator server 203 using a hash of the public key that is determined for a query period.

In some embodiments, if a location query is to be performed via the web-based interface from an electronic device, such as a laptop or desktop device, keys to enable the decryption of the location data may be required to be sent to the electronic device. In one embodiment, decryption keys for the location data may be sent to the server that provides the web-based interface to enable the server to decrypt location data, at least while the location data is being viewed through the web-based interface. Before location data is displayed via the web-based interface, a notice may be presented to inform the user that location decryption keys are being temporarily shared with the web-based interface server to enable location data to be decrypted and presented. In one embodiment, the sharing of the location decryption keys can be performed via an automatic and temporarily delegation of location query rights with a proxy account associated with the web-based interface.

In one embodiment, the wireless accessory 201 can be placed in a light lost mode. In the light lost mode, a set of future public keys can be generated for the wireless accessory and transmitted to the device locator server 203. The device locator server 203 can then notify the mobile device 102 if any location data is received that correspond with a key in the set of future public keys. In one embodiment, a finder device that sends a location for a wireless accessory that is in the light lost mode can be directed by the device locator server 203 to relay a message to the wireless accessory 201 that notifies the wireless accessory that it is in the light lost mode. A similar mechanism can be used to relay a message to the wireless accessory 201 that places the accessory in an explicit lost mode. The explicit lost mode can be enabled by the user via the device locator UI 204. In the explicit lost mode, the wireless accessory 201 cannot be paired with another device unless unlocked by the owner. Additional examples of paired devices using location services may be found in U.S. patent application Ser. No. 16/543,227 filed Aug. 16, 2019 entitled “A System and Method for Locating Wireless Accessories,” which is incorporated by reference herein in its entirety.

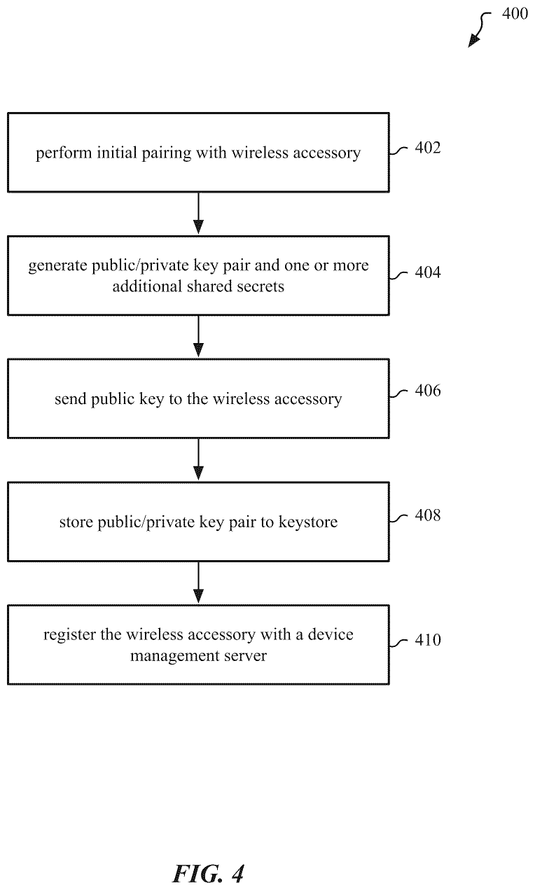

FIG. 4 is a flow diagram illustrating a method for use with the device locator systems according to an embodiment described herein. FIG. 4 illustrates a method 400 to pair a mobile device with a wireless accessory. Aspects of method 400 are also illustrated in FIG. 2 and FIG. 3, as described above. For example, the description of the operations below refers to the mobile device 102, wireless accessory 201 and device locator server 203.

As shown in FIG. 4, method 400 includes an operation (402) that performs an initial pairing with a wireless accessory. The initial pairing can be a Bluetooth pairing or another type of pairing using other wireless radio technologies. During the initial pairing, the mobile device and the wireless accessory can exchange identifiers, passkeys, or other credentials that enables a wireless data exchange to be performed between a mobile or another electronic device and the wireless accessory. On one embodiment the initial paring with the wireless accessory can include the exchange of credentials associated with the wireless protocol for which the pairing is performed, allowing all data exchanged wirelessly to have at least a first layer of encryption.

The mobile device can then generate a public/private key pair and one or more additional shared secrets (404). The device can then send the public key and one or more additional shared secrets to the wireless accessory (406). A variety of key generation techniques can be used. In one embodiment, a variant of ECDH is used to generate a public key pair for encryption. In one embodiment, the one or more additional shared secrets can include an anti-tracking secret that enables the wireless accessory to derive a new public key based on an existing public key.

After generating the public/private keypair and one or more additional shared secrets, the mobile device can store public/private key pair to keystore (408). In one embodiment the keystore is a cloud-based keystore that can be synchronized with other devices associated with the same cloud services account, or family of cloud services accounts, to which the mobile device and wireless accessory are associated. The cloud-based keystore allows the wireless accessory to be located by other synchronized devices. The mobile device can then register the wireless accessory with a device management server (410). Registering the wireless accessory with the device management server can form an association between the wireless accessory and the cloud services account to which the mobile device is associated. In some embodiments, the mobile device may register the wireless accessory and the device group. Information stored in a device group profile for the device group may also be synchronized between devices tied to a cloud services account (e.g., a user account). The device management server can be associated with other cloud-based servers that are used to facilitate cloud-based services accessible to the mobile device, such as the device locator server 203 of FIG. 2 and FIG. 3.

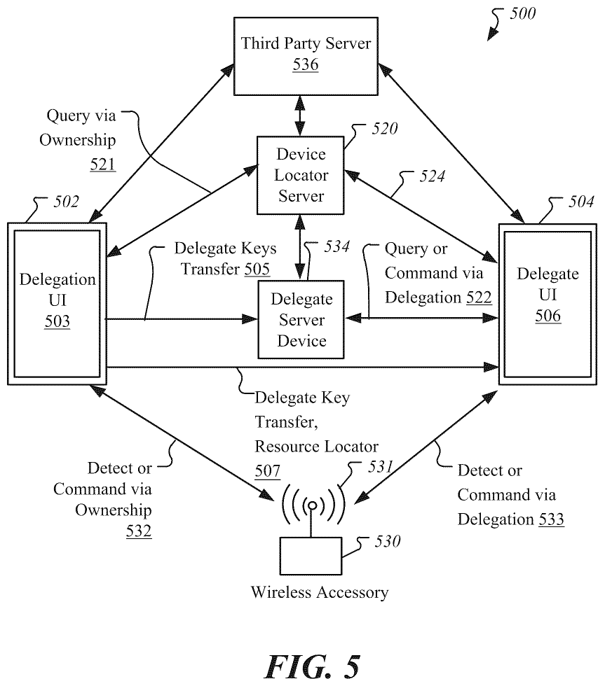

FIG. 5 is a network operating environment for electronic devices, according to an embodiment. FIG. 5 illustrates a system 500 in which access to all or a subset of locator services for a wireless accessory 530 of owner device 502 can be delegated to an external entity for a defined period of time. In one embodiment, the system 500 includes an owner device 502, a delegate device 504, a device locator server 520, a delegate server 534, a third-party server 536, and a wireless accessory 530. The owner device 502 and delegate device 504 can each be a variant of mobile device 102 as described herein. The wireless accessory 530 can be a variant of wireless accessory 201 and/or 101 as described herein. The device locator server 520 can be a variant of device locator server 203 as described herein. The delegate server 534 can be a variant of delegate server 107 as described herein. The delegate server 534 may act as a key escrow and perform all encryption and decryption on behalf of the delegate device 504 in communication with the device locator server 520. By limiting the encryption capabilities and underlying location information of the wireless accessory 530 to the delegate server 534, the encryption capabilities and underlying location information remain opaque to the device locator service provider and the delegate entity.

A user of the owner device 502, via a delegation UI 503, can delegate all or a subset of device locator 520 services to the delegate entity via a transfer 505 of delegate keys to a share record established on the delegate server 534 for the delegate entity. The owner device 502 user can enable or disable the share at any time. Delegation can be performed by the owner device 502 by generating keys for one or more privacy windows expected for the duration of travel and providing those keys to the delegate server 534 via the transfer 505 of delegate keys. The privacy window is a predefined period of time, such as M minutes, that a set of generated keys associated with the wireless accessory 530 are valid. In an embodiment, there is at least one new key for each privacy window. For example, if the duration of travel is expected to be an hour and the privacy window is 15 minutes, then the set of generated keys for the privacy window (e.g., 15 minutes) within the hour will include at least 4 keys. The delegate server 534 may store the delegate keys in a share record in a share database, and the delegate server 534 may encrypt and decrypt data exchanged with the device locator server 520 in response to requests by the delegate device 504 using the delegate keys.

In an embodiment, the delegate entity (e.g., delegate device, sub-delegate device) may exchange a set of delegate shared secrets between a delegate device 504 and the owner device 502. The exchange of delegate shared secrets allows for the generation of cryptographic keys by both the delegate device 504 and the owner device 502 to exchange encryption keys and/or data in response to location information queries. The exchange of delegate shared secrets may be performed out-of-band from the device locator server 520 and/or delegate server 534. The exchange of delegate shared secrets may be sent between the delegate device 504 and the owner device 502, as shown with 507. In another embodiment, the delegate entity may have a third-party application and optionally a corresponding third-party server 536 for the application (e.g., a third-party application server) that facilitates provision of the delegate shared secrets. The delegate shared secrets and/or cryptographic keys generated by the owner device and shared with the delegate entity via the third-party application 536. The delegate shared secrets may be stored at the third-party server 536 for the delegate entity. The delegate entity may determine whether sub-delegates receive the shared secrets and/or cryptographic keys. The data and/or encryption keys that are encrypted with cryptographic keys generated with the delegate shared secrets may be viewed as “wrapped” by the delegate shared secret and may be cryptographically verifiable as being received by a delegate device 504 in possession of valid delegate shared secrets.

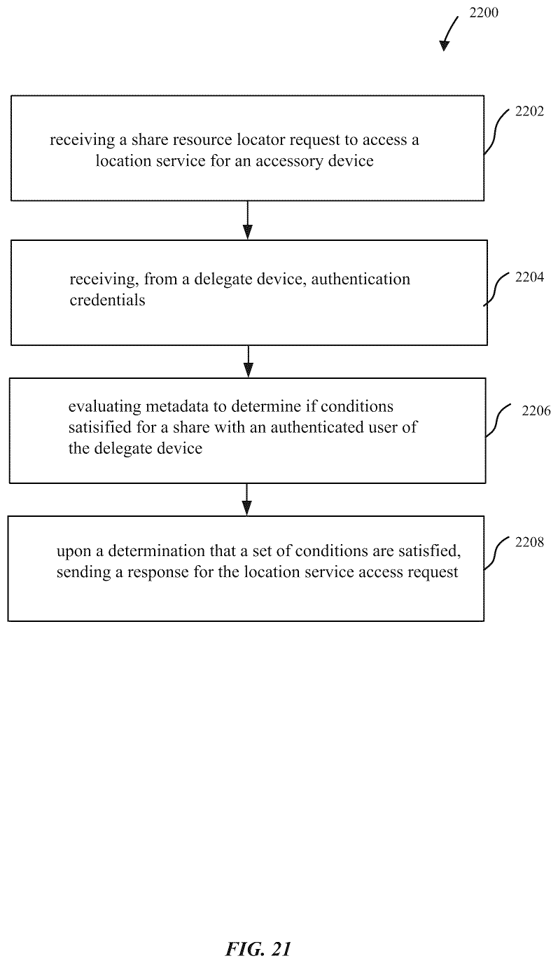

In an embodiment, the owner device 502 may generate a share resource locator to allow for delegation of locator services. The share resource locator may include a delegate shared secret to generate a cryptographic key and/or one or more cryptographic keys that may be used by the delegate device to encrypt/decrypt data received in response to requests for device locator services and/or the owner device 502. In an embodiment, the share resource locator may be implemented as a uniform resource locator (URL) and the delegate device 504 may access the share of the locator services 524 with an application, such as a web browser. In another embodiment, a delegate device 504 may access device locator server 520 with a third-party application provided by third-party server 536. In the case of a third-party application, the shared secret and/or cryptographic keys may be stored at the third-party server 536 for the delegate device 504. Some embodiments may include the shared secret and/or one or more cryptographic keys in a portion of the share resource locator string that is only accessed within an application (e.g., a web browser) on the delegate device 504 and is not sent with a request with the share resource locator. For example, the portion of the share resource locator string may be implemented as an anchor link in a uniform resource locator request. The owner device 503 may send the share resource locator directly to the delegate device 504 (as shown with 507), third party server 536, and/or via the delegate server device 534. An embodiment of a share resource locator to share locator services is described herein in regards to FIG. 21.

Metadata on the owner device 502 associated with the delegate entity and/or selected by the user on the owner device 502 to associate with the delegate entity for the share may be used to determine the number of privacy windows and associated delegate keys to provide for the delegate entity. For example, if the user of the owner device 502 selects to associate a particular flight with the delegate entity, then the delegate keys generated by the owner device may include a number of privacy windows expected for the duration of the travel by the owner and/or expected duration of time that the delegate entity may need to transport luggage for the owner. The metadata may also establish the period of time that the share record with the delegate keys should exist in the share database for the delegate server 534. For example, the share record may be torn down automatically when the duration of travel by the owner is expected to end or the bags are likely to be reclaimed.

The transferred delegate keys can enable the delegate device 504, via delegate server 534, to perform a set of operations including, but not limited to, tracking, accessing, using, or controlling the wireless accessory 530. For example, the owner device 502 can delegate to the delegate entity the ability to detect 533 the wireless accessory 530 via a beacon signal 531 transmitted by the wireless accessory 530 provided the delegate device 504 satisfies the set of conditions. The owner device 502 can also delegate the ability to query 522 a location of the wireless accessory 530 via the delegate server 534 provided the delegate device 504 satisfies the set of conditions.

An authenticated user of the delegate device 504 associated with the delegate entity may access locator services 522 upon request to delegate server 534 after satisfying a set of conditions. The set of conditions may be established by the device owner and/or the delegate entity. The set of conditions may be for a state of the owner device 502, the status of the wireless accessory 530, the delegate device 504, and/or the authenticated user of the delegate device 504. The set of conditions may be time-based conditions, geo-based conditions, conditions based on status of the wireless accessory 530, and/or location of the owner device 502 or sharee of the owner device (e.g., 504). For example, if the owner device 502 is near the wireless accessory 530, then the delegate device 504 may not be able to request device locator services. Continuing with the example, to ensure that locator services are not permitted when the owner device 534, the following conditions may need to be met for the delegate device 504 to request locator services: wireless accessory status is not near owner, wireless accessory status is not near sharee, device locator request is requested during a delegate entity event for the owner device 502, the wireless accessory current or last known location was not a safe location of the owner device 502, and/or the user has not explicitly ended the delegation of locator services.

In another example, a geo-based condition establishes that a delegate must be located in a geographical location associated with the delegate entity. Continuing with the example, the delegate entity may use a geofence to determine whether a delegate device 504 is in a geographical location that satisfies the geo-based condition. In an embodiment, the wireless accessory 530 is defined as near to a particular device when the particular device is either wirelessly or physically connected to the wireless accessory 530. In another embodiment, the wireless accessory 530 is defined as near to a particular device (owner device or sharee device) if the particular device is within range to receive a beacon signal range from the wireless accessory 530. For example, the owner device 534 is near to the wireless accessory if the owner device 534 is either wirelessly connected or physically connected to the wireless accessory 530. In another example, a delegate of the delegate entity may send information on the location of the accessory device and designate the accessory device as near the owner device. For example, sub-delegate of the delegate entity may hand the accessory device 530 back to the owner and designate the accessory device as with the owner device and designate the accessory device 530 as near the owner.

In some embodiments, the set of conditions for the authenticated user of a delegate device 504 for accessing locator services for the wireless accessory 530 may be implied based on metadata accessible on owner device 502 associated with an event with the delegate entity. For example, a condition for servicing device locator requests for luggage may be that the owner device 502 has dropped off their luggage at check-in for their flight. The set of conditions for the user of the delegate device 504 may optionally be explicitly provided by the owner device 502 and/or the delegate entity. The delegate entity may establish a set of conditions for access to device locator services for delegate devices. For example, the delegate entity may create a set of conditions based on particular employee roles (i.e., role-based conditions), particular employees, geo-based conditions, wireless accessory status, time-based conditions, delegate device identifiers, and/or any other conditions. The delegate entity airline carrier may establish conditions that are time-based for each agent role that is expected to need device locator services while the item is en route to a destination. For example, the delegate entity airline carrier may set time-based conditions on use of the device locator services for the roles of: a check-in agent, a baggage handler, a baggage reclaim agent, etc. By way of further example, the check-in agent and baggage handlers may be permitted to play sound on the wireless accessory only when the baggage is expected to be near the check-in agent and the check-in agent may have a limited time to use the play sound feature tied to expected location of the baggage while en route. The device locator services permitted may change dynamically, for example, if the wireless accessory 530 has a status of lost.

The specific functionality that is delegated to the delegate device 504 can be determined in part based on a set of specific keys 507 that are permitted to be used by the authenticated user of the delegate device 504. For example, the employee role of the authenticated user of the delegate device 504 and delegate device 504 location may determine the set of specific keys that are accessible to the delegate device 504. Continuing with the example, the baggage handler located in a baggage storage facility may be permitted to play sound on the wireless accessory to locate the luggage only when the status of the wireless accessory 530 is lost or when the owner is going to miss their flight.

In an embodiment, the owner device 502 may directly provide specific public keys 507 to the delegate device 504 allowing for communication with the wireless accessory 530, the delegate server 534, or the device locator server 520 directly. For example, the owner device 502 may provide public keys 507 directly to the delegate device 504 to allow the delegate device 504 to directly request that the wireless accessory 530 play sound to allow the user of the delegate device 504 to find the wireless accessory, such as a locator tag attached to luggage. In another example, a locator tag wireless accessory 530 may have a low battery and the owner device 502 may request that the delegate server 534 provide public keys to allow a delegate device 504 to encrypt and send location information regarding an item, such as luggage, to the device locator server 520. The owner device 502 may create a set of conditions for the delegate device 504 to use the public keys. For example the owner device 502 may provide a set of delegate public keys for a single privacy window of N minutes to an agent of the delegate entity, such as a check-in agent or baggage handler, to allow the agent to direct the wireless accessory 530 to play a sound and enable the agent to locate the luggage when the wireless accessory 530 has a status of lost and/or not near owner.

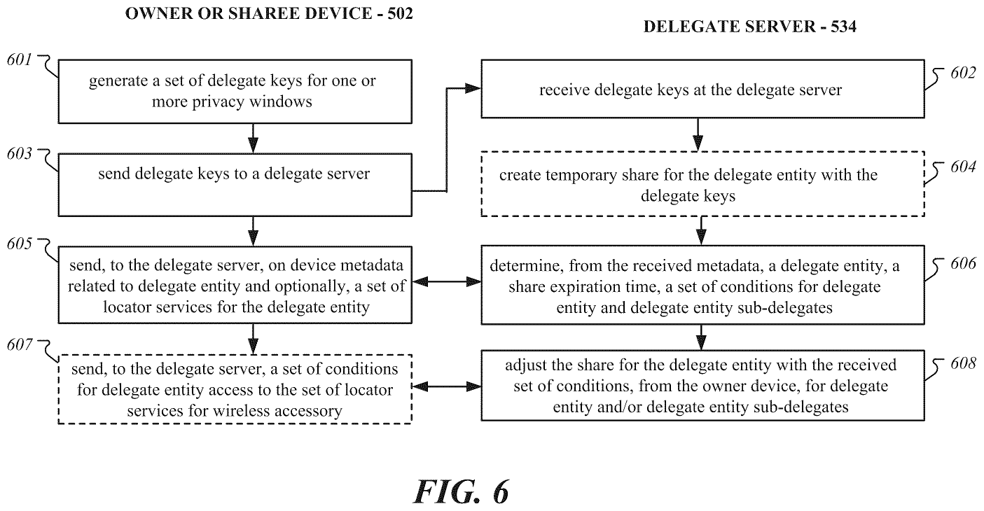

FIG. 6 is a flow diagram illustrating methods for use with device locator systems, according to an embodiment. In flow diagram 600, owner/sharee device 502 uses an application programming interface (API) to send requests to delegate server 534 to create a share record and establish a delegate entity for the wireless accessory 530 based on metadata accessible on the owner device 502. Although specific examples have been provided throughout the description referring to an owner device 502 delegating locator services, those with skill in the art will recognize that the owner device 502 may share cryptographic information with a sharee device and the sharee device may be capable of generating keys in the same manner as the owner device 502 to create a share with a delegate entity as described herein.

Initially, owner device 502 may generate delegate keys for one or more privacy windows for the wireless accessory device 530 (601). The number of privacy windows of the wireless accessory and corresponding number of delegate keys generated may be at least partially based on an expected duration of an upcoming event with the delegate entity. Metadata on the owner device 502 related to the delegate entity may be used to predict the expected duration of the event. For example, the owner device 502 may associate metadata with the delegate external entity airline carrier including, but not limited, to the following: calendar data related to a flight, a flight number, a baggage claim identifier, a boarding pass, historical data on flight duration for airline carrier, historical data on average time for passengers to reclaim baggage, flight gate information, baggage carousel locations in arrival airport, weather data, and/or any other information accessible on the owner device 502 that may indicate the duration of travel and/or duration of time to reclaim baggage. Continuing with the example, the delegate keys are generated in accordance with the number of privacy windows expected during the predicted duration that luggage associated with the wireless accessory 530 is in the care of the airline carrier. In an embodiment, a set of delegate keys may be provided to the delegate server 534 for each device locator request by the delegate device 504 and/or a set of delegate keys may be provided for a portion of a time period for the share of device locator services with the delegate entity.

Although embodiments are described herein with an owner device 502 (or sharee device) possessing the capabilities to maintain and/or create the share, those with skill in the art will recognize that the owner may provide these capabilities to maintain and/or create the share to other devices. The capabilities to maintain and/or create the share include, but are not limited to, the following: generating keys based on secret information (e.g., shared secrets) shared between the owner device 502 and the wireless accessory 530, generating public hashes, access to metadata, access to encryption keys, sending share resource locators, and/or generating delegate keys in order to create a share and/or delegate device locator services. In particular, the user of the owner device 502 may entrust other devices to maintain and/or the share when the owner device 502 is offline to ensure that stale location information is not provided to delegates. For example, if the owner device 502 (or sharee device) is offline and/or the owner device 502 is not accessible when a location request is received and/or a set of delegate keys are requested for generation to service a location request, then another device from a set of devices associated with the owner device 502 may be selected to generate the delegate keys.

The owner device 502 may provide the necessary data and entitlements to maintain and/or create the share on behalf of the owner. The owner device 502 may entitle other devices associated with an online account associated with the owner device. The online account associated with the owner account can be a user account for the owner of the owner device, and the devices may be second devices used by the owner of the owner device 502. The online account may be an account from a set of online accounts owned by other users, such as a set of a family online accounts or one or more online accounts of sharees. In one embodiment, a cloud-based (e.g., a server-based) keystore may provide the shared information to provide the other devices with the capability to maintain and/or create the share and the keystore can be synchronized with other devices associated with the same cloud services account, or family of cloud services accounts, to which the owner device 502 and optionally, wireless accessory 530 are associated. The set of devices associated with the owner device may be associated with an online account for a user of the owner device, such as a cloud-based (e.g., a server-based) services account and/or another type of online account for the user of the owner device 502. For example, one or more of the set of devices associated with the owner device may be logged into and/or used to access an online account for the user of the owner device 502, such as a laptop, a smartphone, a wearable device, and/or a smart home device. In another example, one or more of the set of devices associated with owner device are a set of online accounts that the user of the owner device has designated as trusted and has shared the capability to generate delegate keys.

In some embodiments, the other devices with the In an embodiment, the owner device and set of other devices associated with the owner device may use an implementation of leader election to select a “leader” device from the owner device 502 and a set of devices associated with the owner device 502 that will serve as a selected device “leader” to maintain and/or create the share. A leader device may be selected when the owner device 502 is offline and/or when maintaining or creating the share may be too resource intensive for the owner device 502 with request are received.

Next, the owner device 502 sends the generated delegate keys to the delegate server 534 for the delegate entity (603). The delegate keys enable the delegate devices of the delegate entity to utilize locator services for the wireless accessory device 530 and update location information for the item associated with the wireless accessory device. The delegate entity may designate a set of delegate devices 504 and/or delegate agents/employee roles that are authorized to utilize delegated locator services. The delegate server 534 receives the delegate keys (602) and creates a temporary share record for the delegate entity and stores the delegate keys in the share database (604). The temporary share record may exist for the duration of the event for the delegate entity and/or a set of share expiration conditions may be defined to cause the share record to be torn down and/or deleted from the share database. For example, in the case of an airline carrier delegate entity, the share expiration conditions may include, but are not limited to, the following: baggage reclaimed by owner or sharee, cancelation of travel, and/or explicit request to end delegation of locator services by owner/sharee device 502.

The owner device 502 sends metadata associated with the delegate entity and optionally, a set of locator services accessible by the delegate entity (605). In response, the delegate server 534 determines, from the received metadata, a delegate entity, a share expiration time, a set of conditions for the delegate entity, and/or delegate entity sub-delegates. Optionally, the owner device 502 may send a set of conditions for the delegate entity to access the set of device locator services (607). Upon receipt of an explicit request from the owner device 502, the delegate server 534 may adjust the share for the delegate entity with the received set of conditions, from the owner device 502, for delegate entity and/or delegate entity sub-delegates stored in the share for the delegate entity to access device locator services (608).

In an embodiment, the device locator services are accessible to the delegate entity when a set of actions by the device owner are performed that indicate the beginning of the scheduled event with the delegate entity. For example, the delegate entity airline carrier and respective sub-delegate agents may be permitted to access device locator services after the device owner has checked in and dropped off their luggage with the airline carrier.

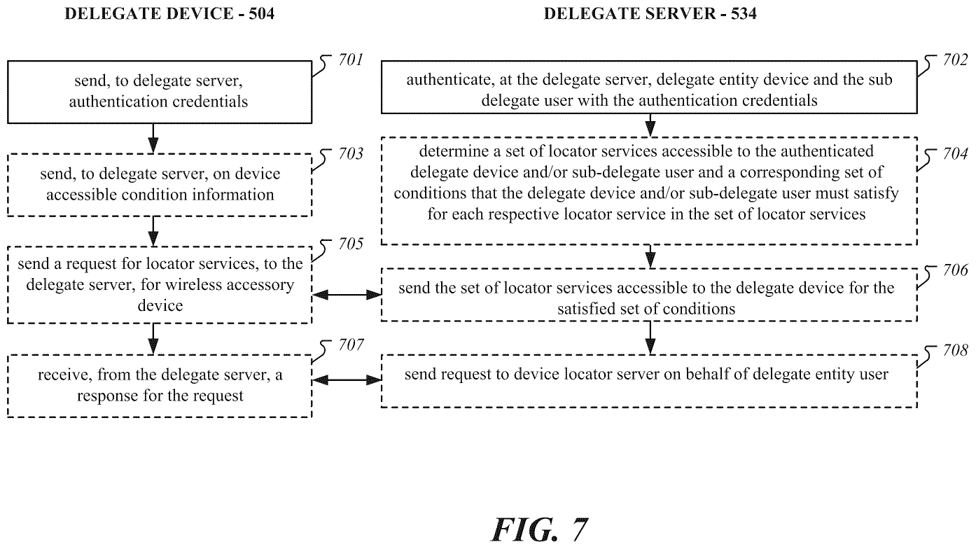

FIG. 7 is a flow diagram illustrating methods for use with device locator systems, according to an embodiment. Initially, delegate device 502 sends authentication credentials to delegate server 534 (701). Upon successful authentication of the user of the delegate device 502 by the delegate server 534, the process continues for delegate device 502. The delegate server 534 authenticates the delegate device 504 and/or the sub-delegate user with the authentication credentials (702). The delegate device 502 may send to delegate server 534, on-device accessible condition information for the delegate device 502 and sub-delegate user (703). In parallel, or in response to successful authentication by the delegate server 534 (702), the delegate device 502 may send to the delegate server 534, a request for locator services (705). In some embodiments, the request may be sent by the delegate device 502 with a share resource locator. The share resource locator request may be received by the delegate server 534 via the third-party server 536 and/or the device locator server 520.

The delegate server 534 determines a set of locator services accessible to the authenticated delegate device 504 and/or sub-delegate user (704). The delegate server 534 determines a corresponding set of conditions that the delegate device 504 and/or sub-delegate user must satisfy for each respective locator service in the set of locator services (704). By way of example, the delegate device 504 with a particular device identifier and/or in use by an authenticated sub-delegate user may have access to the following locator services: report the location of an item, locate the wireless accessory device, and/or request that the wireless accessory device play sound. In an embodiment, the sub-delegate user must satisfy a condition that the sub-delegate user has a particular agent role (e.g., check-in agent, baggage handler, etc.) with the delegate entity in order to access the device locator services. Each locator service in the set of locator services accessible to the authenticated delegate device 502 may have a corresponding set of conditions that must be satisfied in order for the delegate server 534 to respond to the request and/or send the request to the device locator server 520 on behalf of the delegate device 504. For example, a baggage handler may need to satisfy the following set of conditions in order to play sound at the wireless accessory device 530: send request to play sound at baggage claim for airline from delegate device 504 assigned by delegate entity, delegate device 504 is located in expected area of baggage storage facility or near airplane, and wireless accessory device 530 state may not be near owner.

In an embodiment, the device locator server 520 receives a share resource locator request 520 from the delegate device 504, the share resource locator includes a unique identifier that may be used to look up a share identifier and corresponding share and delegate keys at the delegate server. The device locator server may send the request for the device locator service and the unique identifier to identify the share identifier to the delegate server 534 to look up the share and delegate keys for the share.

Upon receipt of a request for a device locator service, delegate server 534 receives inputs on all relevant conditions for the requested device locator service, evaluates the conditions, and determines whether to send the request to the device locator server 520 on behalf of the delegate device 504 and/or sub-delegate user. Inputs evaluated by the delegate server 534, may include, but are not limited to, the following: wireless accessory device status, item location, owner location, duration of scheduled event, environmental factors (e.g., weather), delegate device state or location, and/or sub-delegate authenticated user. By way of example, the conditions may be time-based conditions, location-based conditions, conditions for the wireless accessory status, sub-delegate role conditions, user-based conditions, conditions on device locator services accessible, and/or any combination thereof.

Optionally, delegate server 534 may send the set of locator services accessible to the delegate device for display and selection on the delegate device (706). If encryption or decryption is needed to send or receive a response from the device locator server 520, then the delegate server 534 uses encryption keys stored for the delegate entity at the delegate server 534. The delegate server 534 sends the request for locator services to the device locator server 520, if the conditions for the request are satisfied (708). The delegate device 502 receives a response for the selected request for locator service from the delegate server 534 (707). In some embodiments, the delegate server may send the response to the device locator server 520 to respond to the request and forward to the delegate device 504.

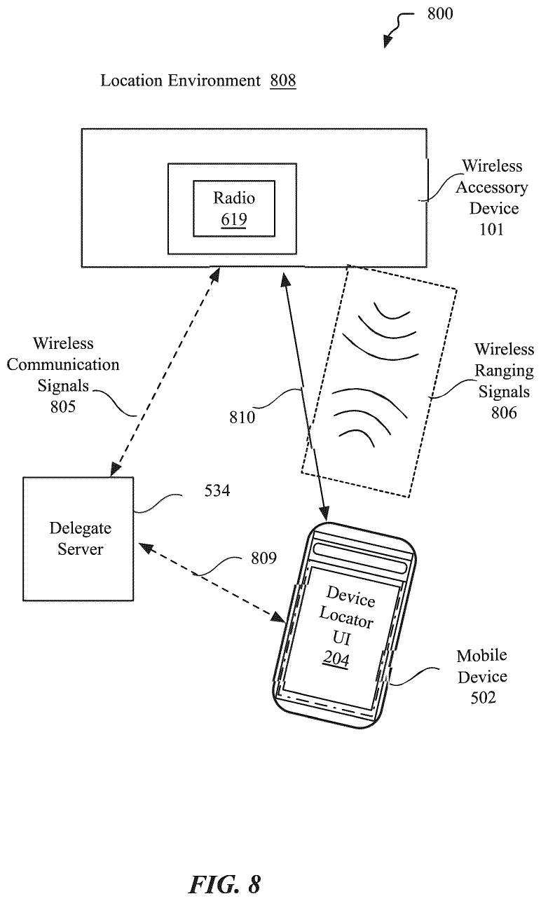

FIG. 8 is an operating environment 800 for electronic devices, according to an embodiment. The devices 101 and 502 can communicate wirelessly via wireless communication signals 605 and detecting one another by scanning wireless channels, transmitting and receiving beacons or beacon frames on wireless channels, establishing connections (for example, by transmitting connect requests), and/or transmitting and receiving packets or frames (which may include the request and/or additional information, such as data, as payloads). In location environment 808, mobile delegate device may receive detect a beacon signal from wireless accessory 101. The wireless communication signals 810 can be carrier signals that conform to wireless communication technologies such as, but not limited to Wi-Fi or Bluetooth. In addition to wireless communication, the mobile device 102, smart home device(s), and/or the wireless accessory device 101 perform wireless ranging operations using wireless ranging signals 806 (as shown between mobile device 502 and wireless accessory device 101). The wireless ranging signals can be, for example, ultra-wideband signals that can be used to determine a distance and/or angle between the wireless accessory device 101 and the mobile device 102 using techniques described herein.

In one embodiment, the wireless accessory 101 can periodically transmit a wireless beacon signal. The wireless accessory 101 can transmit the beacon signal using one of a variety of wireless technologies described herein (e.g., Bluetooth, Wi-Fi, etc.) and in one embodiment can also beacon using an ultra-wide band (UWB) radio technology. The beacon signal can be transmitted using a single wireless technology, one of multiple selectable wireless technologies, or multiple simultaneous wireless technologies. The beacon signal can transmit a beacon identifier that includes information to specifically identify the individual wireless accessory 101, and/or a device group. In one embodiment, the beacon identifier is a public encryption key associated with the wireless accessory device.

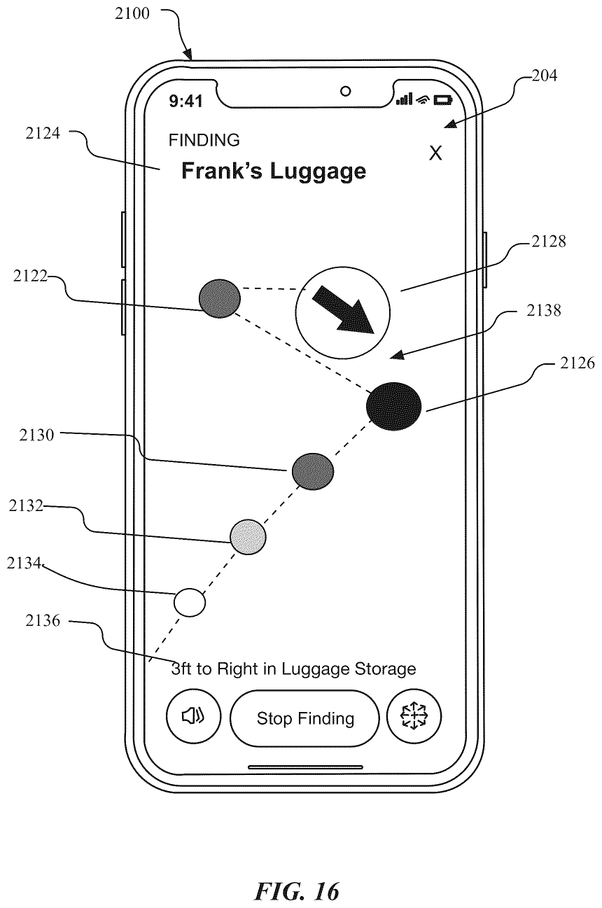

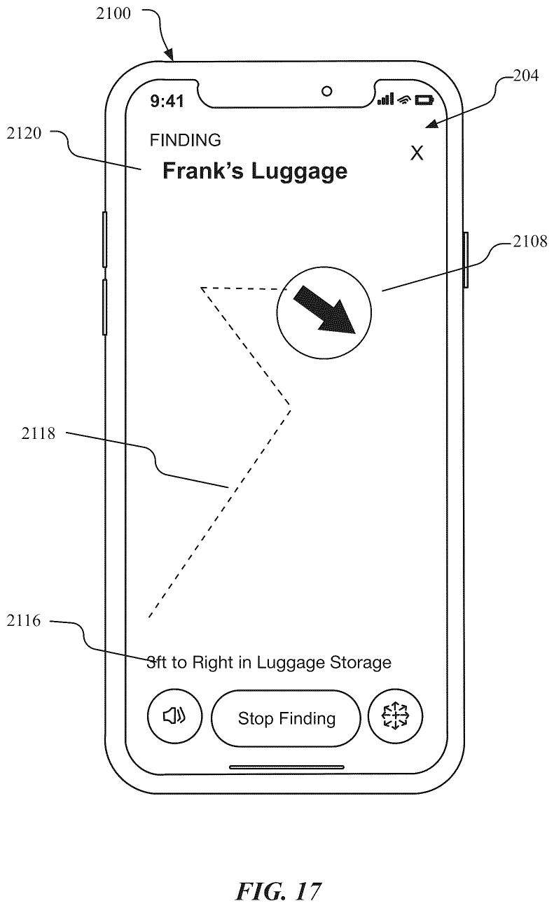

The delegate device 502 may send a request to delegate server 534 for at least one of the following locator services: request to update the wireless accessory device location along the expected route with delegate entity, play sound on the wireless accessory, and/or locate the wireless accessory device using locator finding as described with FIG. 16 and FIG. 17. If the conditions are satisfied for the delegate device 502 and the authenticated user of the delegate device 502, then the delegate device may locator services. By way of example, if the authenticated user is has the agent role of baggage handler and is in the expected storage facility for the airline carrier, then the delegate device may send a request for locator services.

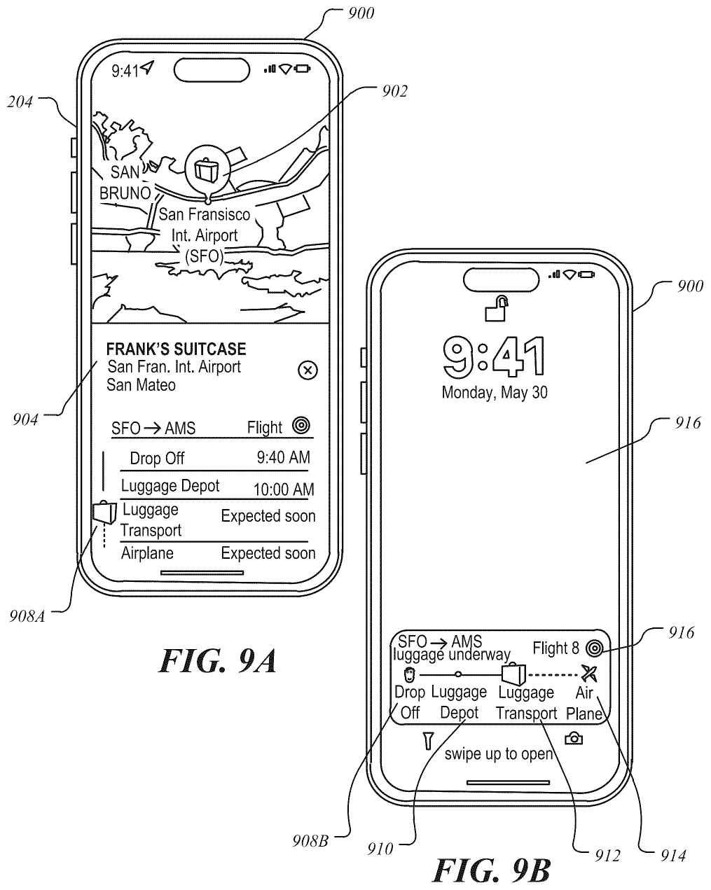

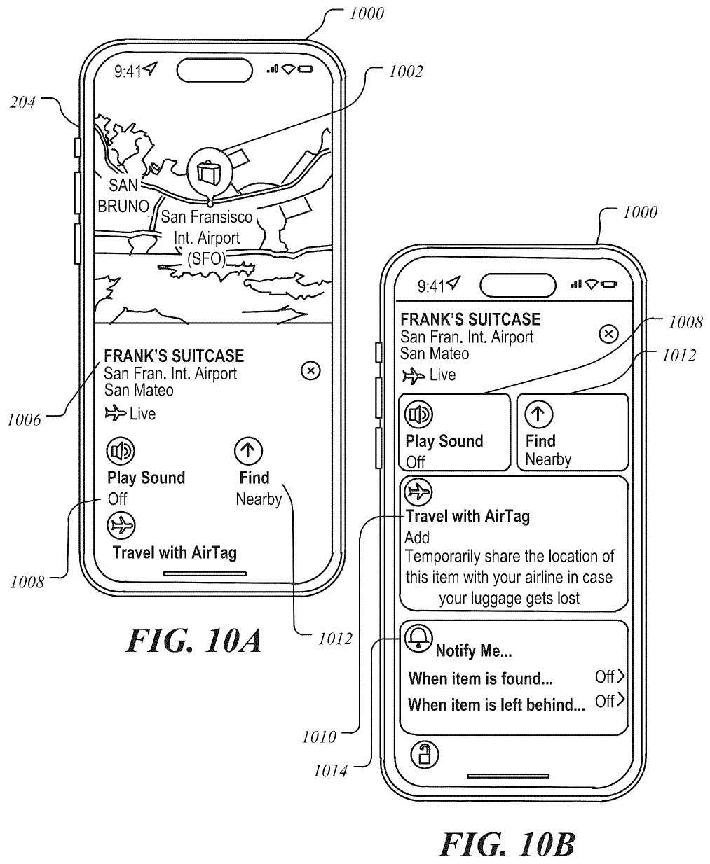

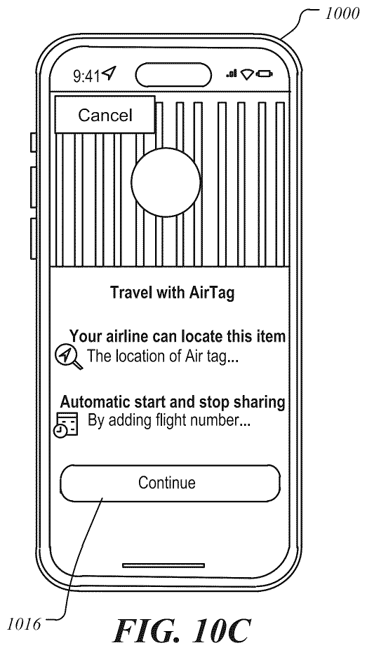

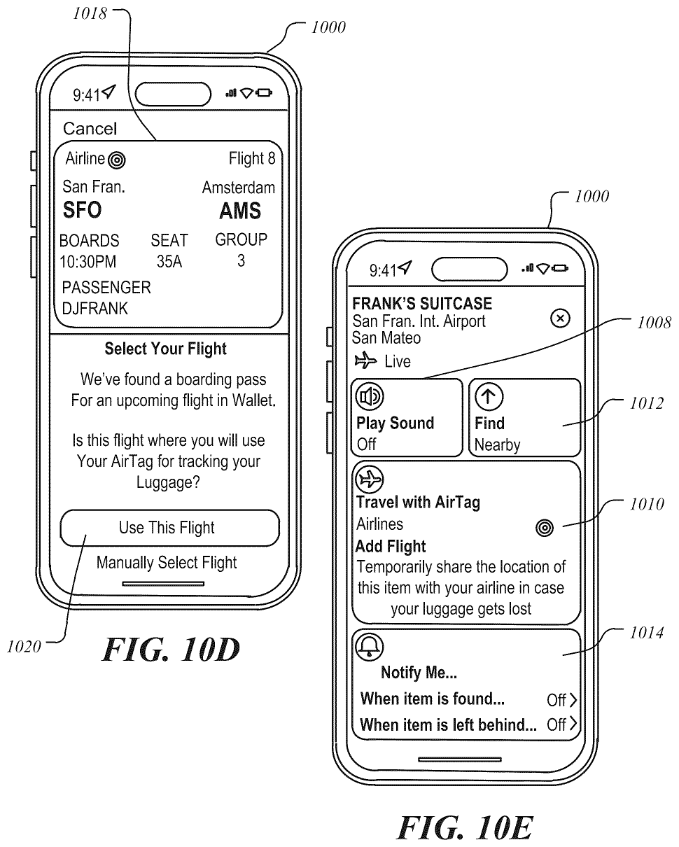

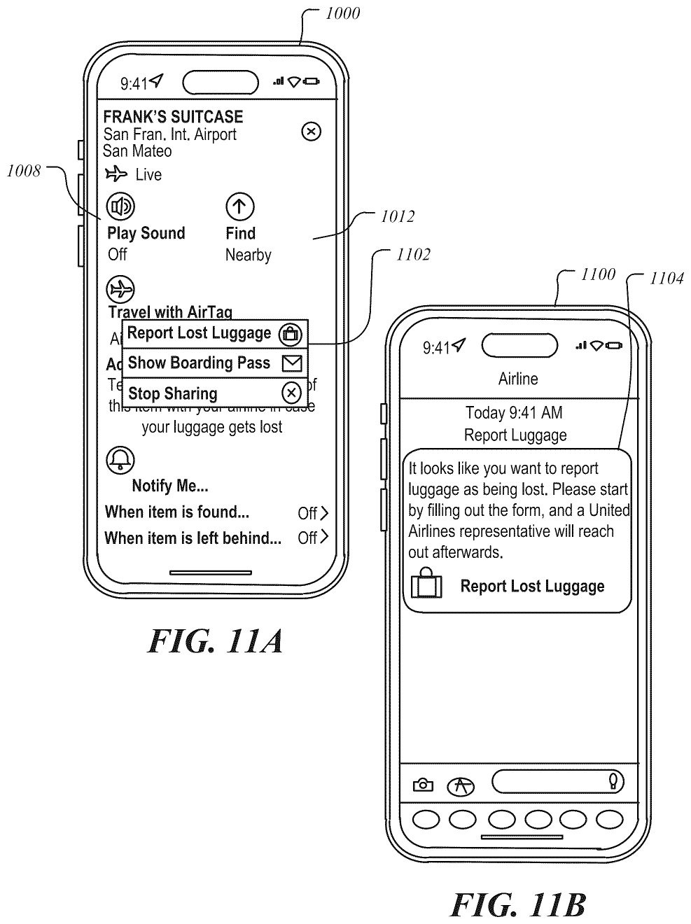

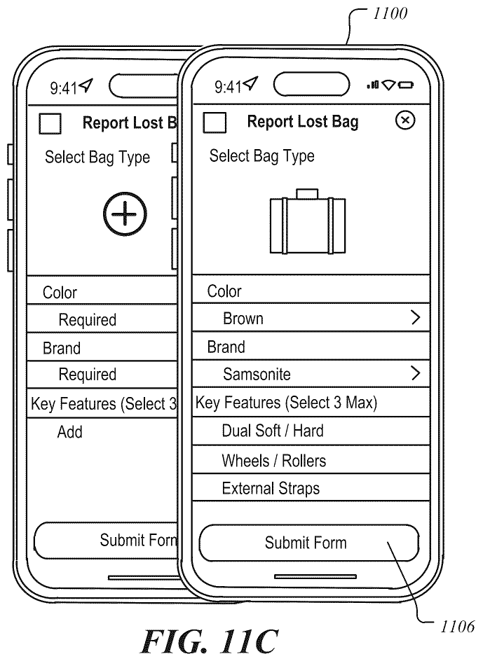

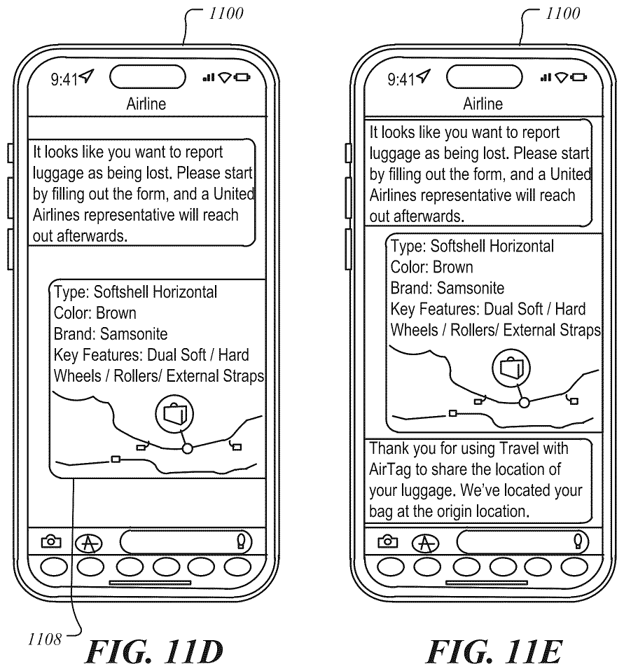

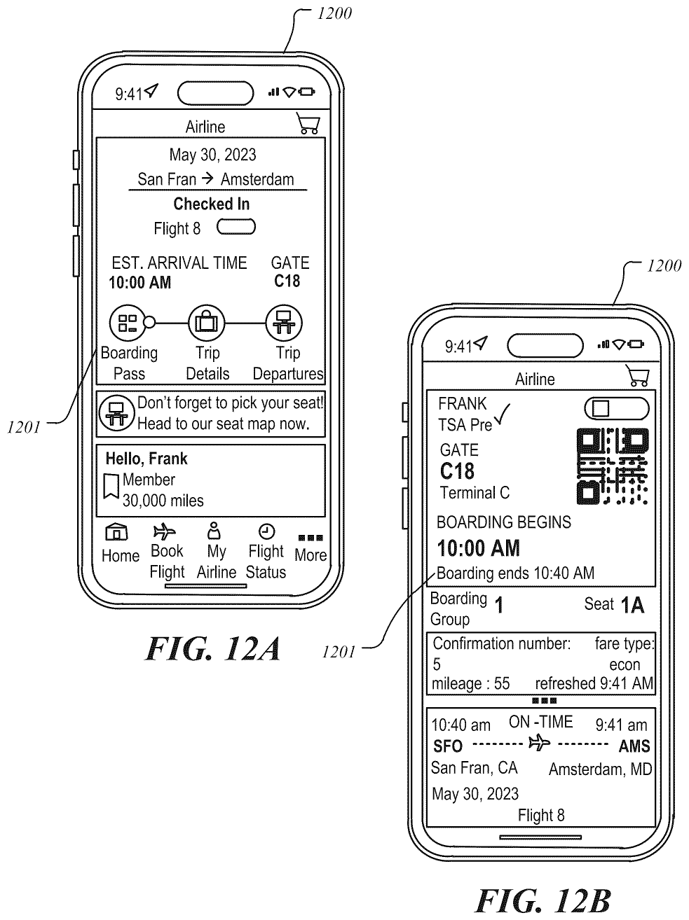

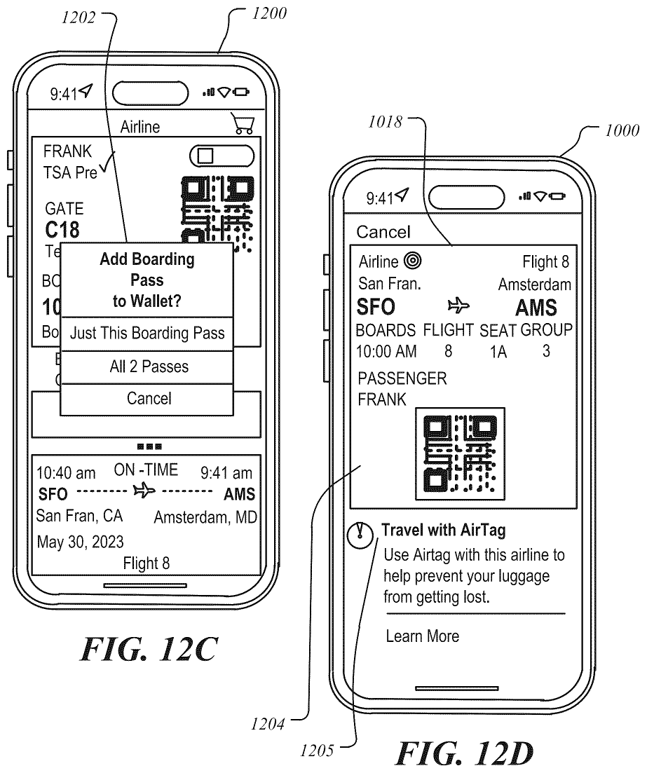

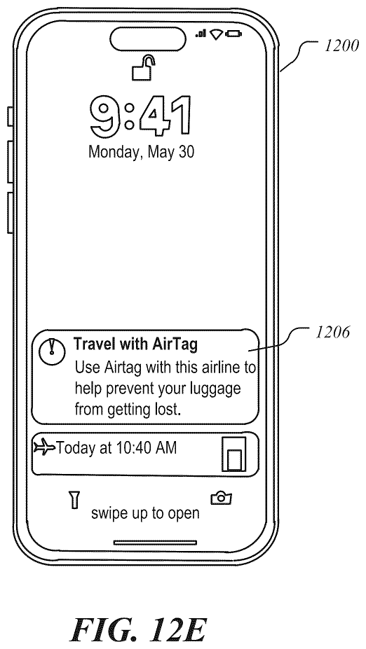

FIG. 9A-12E illustrate delegation user interfaces, according to some embodiments. As shown in FIGS. 9A, the device locator UI 204 can present a graphical user interface in electronic device 900 with accessory device location 902 for item 904 “Frank's Suitcase” and information is presented as shown with 908A from delegate entity on the location status of the luggage. As shown in FIGS. 9B, the device locator UI 204 can present a graphical user interface in electronic device 900 information is presented as shown with 908B from delegate entity on the location status of the luggage on the lock screen at various locations “drop off,” “luggage depot” 910, “luggage transport” 912 and on “airplane” 914 in the care of delegate entity. As shown in FIG. 10A, the device locator UI 204 can present a graphical user interface in electronic device 1000 with wireless accessory device location 1002 with a map and a presentation of affordances for device locator services “play sound” 1008, “find nearby” 1012 for item 1006 “Frank's Suitcase.” As shown with FIG. 10B, the device locator UI 204 can present a graphical user interface in electronic device 1000 with affordances to share the location of an item with an airline 1010 and device locator service to notify when found or left behind 1014 for wireless accessory device. As shown in FIG. 10C, the device locator UI 204 can present a graphical user interface in electronic device 1000 with information on selected device locator services when the “continue” affordance 1016 is selected. As shown in FIG. 10D, the device locator UI 204 can present a graphical user interface in electronic device 1000 with information on the boarding pass 1018 with associated on-device metadata for the owner device that may be associated with the delegate entity. As shown in FIG. 10E, the device locator UI 204 can present a graphical user interface in electronic device 1000 device locator services “play sound” 1008, “find nearby” 1012, “share location” 1010, and “notify when item is found or when item is left behind” 1014 for the owner device with delegate entity “Airline.” As shown with FIGS. 11A-11B, device owner may exchange messages with delegate entity Airline to “report luggage lost”, “show boarding pass”, and/or “stop sharing with affordances” shown as illustrated with 1102. As shown with FIGS. 11C-11E, device owner may report luggage lost by submitting form with affordance 1106 and exchanges messages with delegate entity employees. As shown with FIG. 12A-12D, on-device metadata associated with the wallet application with selected boarding pass information 1201 may be associated with delegate entity. As shown with FIG. 12E, device owner may select to travel with AirTag 1206 from the lock screen in device 1200 user interface.

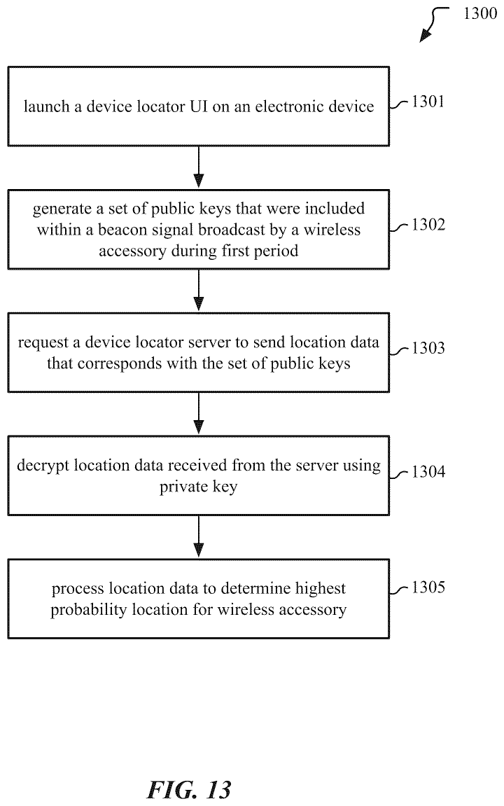

FIG. 13 illustrates a flowchart 1300 for a method to enable location services for a target accessory device, according to an embodiment. As shown in FIG. 13, method 1300 includes an operation in which an electronic device launches a device locator UI (1301). In response to launching the device locator UI, the electronic device, which can be a mobile device as described herein, or another electronic device associated with the same cloud services account as the mobile electronic device, can perform an operation to generate a set of public keys that were included within a beacon signal broadcast by a wireless accessory during a first period (1302). The first period can be, for example, a previous 24 hours. The electronic device is aware of the frequency in which the wireless accessory is to generate new public keys and, using a shared secret generated with the wireless accessory, can generate a set of public keys that correspond with the keys that were generated by the wireless accessory over the first period. The electronic device can then send the set of public keys within a request for the device locator server to send location data that corresponds with the set of public keys (1303). In one embodiment, location data sent by the server in response to the request will be encrypted using the public key transmitted as the beacon identifier of the wireless accessory. The electronic device can decrypt the encrypted location data received by the server using the private key generated during the initial pairing with the wireless accessory (1304). The electronic device can then process the location data to determine the highest probability location for the wireless accessory (1305). In an embodiment, the location data may include data for accessory devices 201 in the device group.

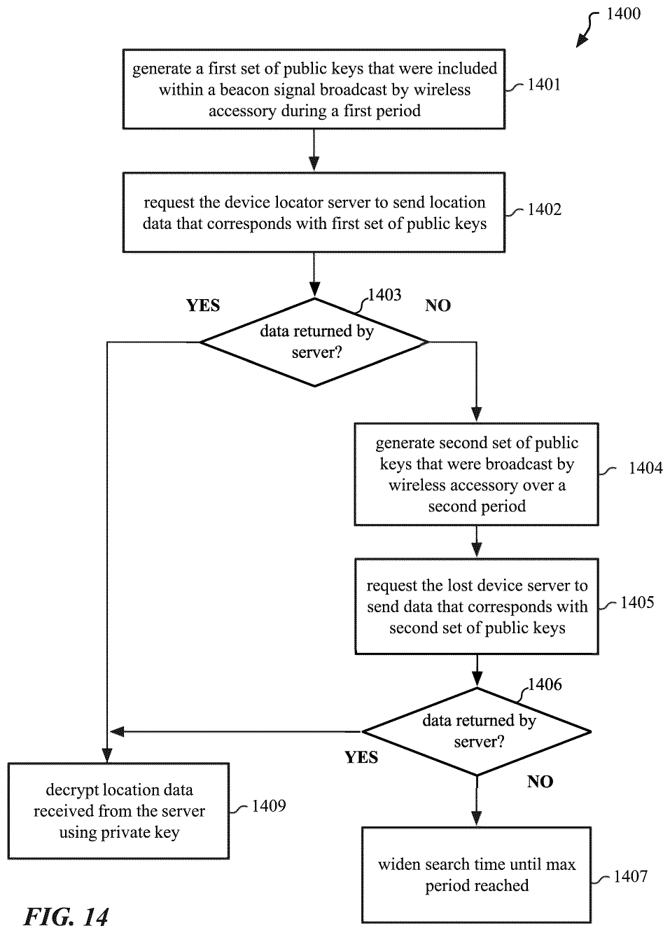

Processing the location data can include a variety of different operations. In one embodiment the location data includes latitude and longitude information along with a timestamp for which the location was determined. The electronic device can triangulate based on the timestamps and remove noise or outlier locations. In one embodiment the location data specifies the location of the finder device that detected the beacon. The location data can additionally include UWB ranging information and/or RSSI information for the beacon detected by the finder device. The electronic device can analyze the UWB ranging information and/or RSSI information in context with the device locations to develop a more accurate location for the wireless accessory. Data that can be transmitted by a finder device and used for location processing is shown in FIG. 14 and described below.

As shown in FIG. 14, method 1400 includes operations that can be performed if the device locator server does not have location data to provide to the electronic device in response to a request. In the case of a device group, the electronic device (e.g., mobile device 102) may provide the location data on devices in the device group. The electronic device can generate a first set of public keys that were included within a beacon signal broadcast by wireless accessory during a first period (1401). The first period can be, for example, 24 hours, although other initial search periods can be used. The electronic device can perform a subsequent operation to request the device locator server to send location data that corresponds with first set of public keys (1402). If the data is returned by the server (1403, “yes”), the electronic device can decrypt the location data received from the server using the private key that corresponds with the set of public keys (block 1409).

If data is not returned by the server (1403, “no”) the electronic device can generate a second set of public keys that were included within a beacon signal broadcast by the wireless accessory during a second period (1404). The second period can be the 24, 48, or another number of hours before the first period. The electronic device can then request for the device locator server to send data that corresponds with the second set of public keys (1405). If, in response to the request, data is returned by the server (1406, “yes”), method 1400 can proceed to block 1409, in which the electronic device decrypts the received data. If data is not returned by the server (1406, “no”), or the server sends a reply that indicates data is not available, method 1400 includes for the electronic device can widen the search time by requesting successively older time periods until the max period is reached (1407).

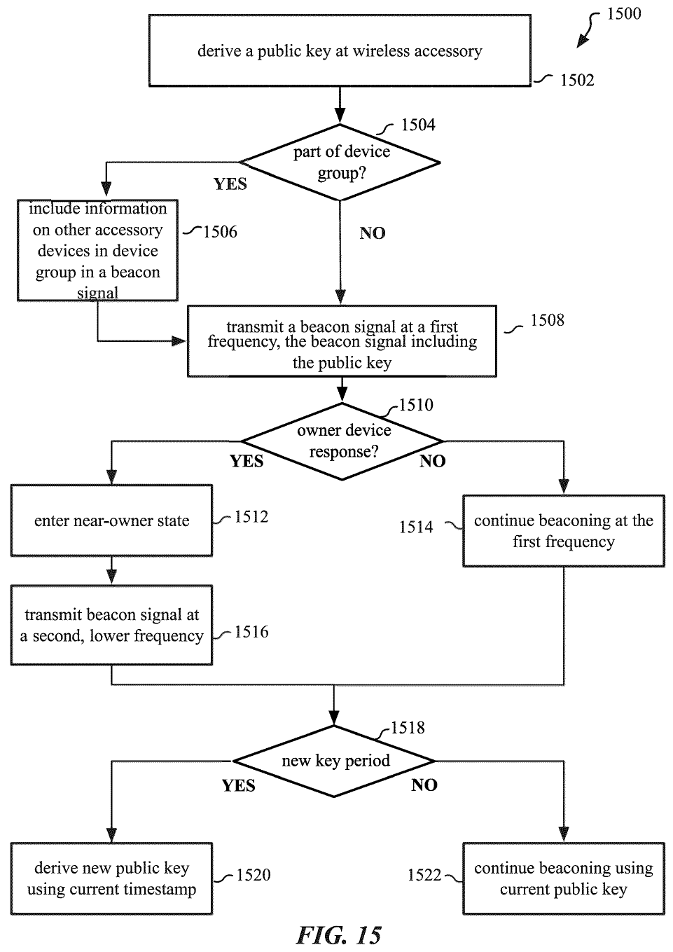

FIG. 15 is a flow diagram illustrating a method 1500 of broadcasting a signal beacon at a wireless accessory, according to an embodiment. Aspects of method 1500 are also illustrated in FIG. 2 and FIG. 3. Method 1500 includes for the wireless accessory to derive a public key (block 1502). The public key can be derived based on a shared secret and a timestamp determined based on a clock or time keeping device of the wireless accessory. Optionally, a determination is made as to whether the wireless accessory is part of a device group (1504). If the wireless accessory is part of a device group, the status information and/or verifiable information for other accessory devices 201 in the device group is provided in the beacon signal (1506). The wireless accessory may indicate status information and/or verifiable information, such as whether any other wireless accessory in the device group is proximate, connected (physically or wirelessly), and/or any other information on the other wireless accessories in the device group. In an embodiment, a set of bits included in the beacon signal may represent each accessory in the device group and setting a Boolean value (e.g., true (1) or false (0)) may indicate whether the respective accessory is proximate and/or connected to the accessory device sending the beacon signal. Alternatively, information is not provided on a device group, if the wireless accessory is not part of a device group (1504). The wireless accessory can then transmit a beacon signal at a first frequency, where the beacon signal includes the public key (1508). The first frequency can vary, and in one embodiment is one beacon every two seconds.

After transmitting a beacon signal, the wireless accessory can listen for a response from the owner device (1510). If the wireless signal receives a response from the owner device (1510, “yes”), the wireless accessory can enter a near-owner state (1512) and begin to transmit the beacon signal at a second, lower frequency (1516). If the wireless accessory does not receive a response from the owner device (1510, “no”), the wireless accessory can continue beaconing at the first frequency (1514).

Method 1500 additionally includes for the wireless device, while beaconing, to rotate the public key every M minutes, where the value of M can vary across embodiments and/or based on the device state. Based on a timer expiration, counter, or another mechanism, the wireless accessory can determine whether the accessory has entered a new key period (1518). While the wireless accessory has not entered a new key period (1518, “no”), the accessory can continue beaconing using the current public key (1522). When the wireless accessory detects that it has entered a new key period (1518, “yes”) the accessory can derive a new public key using the current timestamp (1520). In one embodiment the new public key can be derived using an existing public key, a timestamp, and an anti-tracking secret.

As shown in FIG. 16, the device locator UI 204 can present a graphical user interface in electronic device 2100 with a proximity view using signal strength measurements. The proximity view 2124 for finding “Frank's Luggage” has indicators 2122, 2126, 2130, 2132, 2134, and 2128 at various positions along the trajectory 2138 within the user interface 204. Each indicator may be user interface element that represent proximity to target wireless accessory device 101 by size, color, shape, color gradient, shading, pattern, and/or any other technique for a visual indicator within a user interface. The indicators may be displayed along the trajectory 2138 as the user moves through the location environment. In the proximity view 2104, for example, indicator 2106 is closest to the target wireless accessory device 101 along the trajectory 2138 that the user has taken to find the target wireless accessory device 101 as represented by a darker color and/or a larger size as compared to the other indicators. In some embodiments, user interface 204 proximity view may present ranging information using ranging measurements and present an arrow 2128 indicating the direction of the target wireless accessory device 101 and the distance 2136 to the target wireless accessory device 101. In other embodiments, the trajectory may be shown in a grid, such as a hexagonal grid, with visual indicators consisting of areas of the grid designated with colors, gradients, shading, and/or any other marking along the trajectory plotted on the grid to represent the proximity values for signal strength observed in the respective areas by the mobile device 102, smart home device, and/or combination thereof.

In an embodiment, signal strength measurements from signals received at the mobile device 102 may be used to represent proximity to the target device within the user interface to indicate when the mobile device 102 is proximate to the target device. In some embodiments, signal strength information for the smart home device along the trajectory may be used to present proximity indicators. A “proximity view” 2104 as shown in FIG. 16 may present proximity information using visualization techniques to present the proximity information in relation to a target wireless accessory device 101. In an embodiment, the proximity view 2104 has visual indicators, such as user interface elements, positioned along a trajectory 2118 presented within the user interface 204 to represent a path the user has taken in their search. In some embodiments, the visual indicators may be user interface elements displayed with a gradient, a color, a color gradient, a size, a shape, and/or any other visualization technique to represent signal strength values and a corresponding defined proximity category (e.g., far, near, close, etc.) to the target device. The proximity view 2104 for finding “Frank's Luggage” has indicators 2102, 2106, 2110, 2112, and 2114 at various positions along the trajectory 2118 within the user interface 204. Each indicator in proximity view 2104 may be a user interface element that represents proximity to the target wireless accessory device by size and color gradient within the user interface 204. In the proximity view 2104, for example, indicator 2106 is closest to the target wireless accessory device along the trajectory 2118 that the user has taken to find the target wireless accessory device as represented by a darker color and/or a larger size as compared to the other indicators (e.g., 2102, 2110, 2112, and 2114). Embodiments may use visual inertial odometry (VIO) measurements to determine the trajectory 2118 that a user has taken in their search within the user interface 204. VIO provides the ability to track movement of a mobile device 102 in an arbitrary initial coordinate system. VIO techniques include the analysis of a sequence of images collected with the mobile device to estimate camera motion over the sequence of images.

In some embodiments, the mobile device 102 may move to be within a threshold range of the target accessory device 101 allowing for a ranging process using communication between the mobile device and the target device to determine a distance from and direction to the target device. As shown in FIG. 17, a “ranging view” 2120 of the user interface 204 may provide a distance measurement 2116 in addition to the direction 2108 to the target device that may be selectively displayed. The proximity view 2104 for finding the target device may be used when ranging data for a ranging view 2120 is not available due to a target device not being within a threshold range of the mobile device 102, a target device 101 transmitter not being in a field of view of a receiver at the mobile device, and/or a mobile device does not have a nearly unobstructed view to the target device 101, in some embodiments. The target device 101 may be in the field of view of the mobile device 102 when the receiver at the mobile device 102 has a view of the target device transmitter.

In some embodiments, ranging using an ultra-wide band (UWB) radio technology may provide relatively precise location or distance data to a target device, but are a relatively short-range radio frequency (RF) technology wireless communication as compared to Bluetooth technology. In some embodiments, it may be desirable for the mobile device 102 UWB receiver to have line of sight to the target device transmitter or a nearly unobstructed view of the target device to obtain optimal ranging location data. Proximity information in the form of signal strength information may be relatively less precise in comparison to UWB but may cover a wider area offering a longer range and can be obtained from advertisements before the wireless radio connection is established. Bi-directional communication may not be established with a connection between the mobile device and target device, but advertisements received at the mobile device may provide signal strength information to aid in directing the user to the target device prior to establishing a connection, in some embodiments. The combination of techniques may assist the user in locating the target wireless accessory device.

In various embodiments, description is made with reference to figures. However, certain embodiments may be practiced without one or more of these specific details, or in combination with other known methods and configurations. In the following description, numerous specific details are set forth, such as specific configurations, dimensions and processes, etc., in order to provide a thorough understanding of the embodiments. In other instances, well-known semiconductor processes and manufacturing techniques have not been described in particular detail in order to not unnecessarily obscure the embodiments. Reference throughout this specification to “one embodiment” means that a particular feature, structure, configuration, or characteristic described in connection with the embodiment is included in at least one embodiment. Thus, the appearances of the phrase “in one embodiment” in various places throughout this specification are not necessarily referring to the same embodiment. Furthermore, the particular features, structures, configurations, or characteristics may be combined in any suitable manner in one or more embodiments.

In the discussion that follows, a computing device that includes a touch-sensitive display is described. It should be understood, however, that the computing device may include one or more other physical user-interface devices. The various applications that may be executed on the device may use at least one common physical user-interface device, such as the touch-sensitive surface. One or more functions of the touch-sensitive surface as well as corresponding information displayed on the device may be adjusted and/or varied from one application to the next and/or within a respective application. In this way, a common physical architecture (such as the touch-sensitive surface) of the device may support the variety of applications with user interfaces that are intuitive and transparent.

Some processes are described below in terms of some sequential operations. However, it should be appreciated that some of the operations described may be performed in a different order. Moreover, some operations may be performed in parallel rather than sequentially.

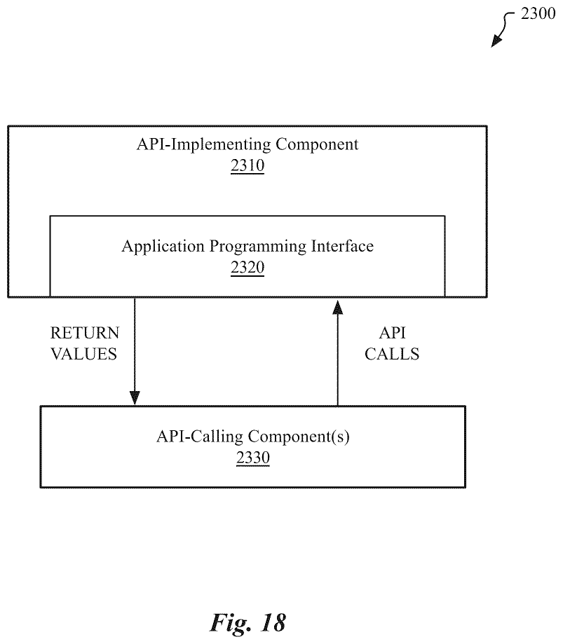

FIG. 18 is a block diagram illustrating an exemplary API architecture, which may be used in some embodiments of the invention. As shown in FIG. 18, the API architecture 2300 includes the API-implementing component 2310 (e.g., an operating system, a library, a device driver, an API, an application program, software or other module) that implements the API 2320. The API 2320 specifies one or more functions, methods, classes, objects, protocols, data structures, formats and/or other features of the API-implementing component that may be used by the API-calling component 2330. The API 2320 can specify at least one calling convention that specifies how a function in the API-implementing component receives parameters from the API-calling component and how the function returns a result to the API-calling component. The API-calling component 2330 (e.g., an operating system, a library, a device driver, an API, an application program, software or other module), makes API calls through the API 2320 to access and use the features of the API-implementing component 2310 that are specified by the API 2320. The API-implementing component 2310 may return a value through the API 2320 to the API-calling component 2330 in response to an API call.

It will be appreciated that the API-implementing component 2310 may include additional functions, methods, classes, data structures, and/or other features that are not specified through the API 2320 and are not available to the API-calling component 2330. It should be understood that the API-calling component 2330 may be on the same system as the API-implementing component 2310 or may be located remotely and accesses the API-implementing component 2310 using the API 2320 over a network. While FIG. 18 illustrates a single API-calling component 2330 interacting with the API 2320, it should be understood that other API-calling components, which may be written in different languages (or the same language) than the API-calling component 2330, may use the API 2320.

The API-implementing component 2310, the API 2320, and the API-calling component 2330 may be stored in a machine-readable medium, which includes any mechanism for storing information in a form readable by a machine (e.g., a computer or other data processing system). For example, a machine-readable medium includes magnetic disks, optical disks, random-access memory; read only memory, flash memory devices, etc.

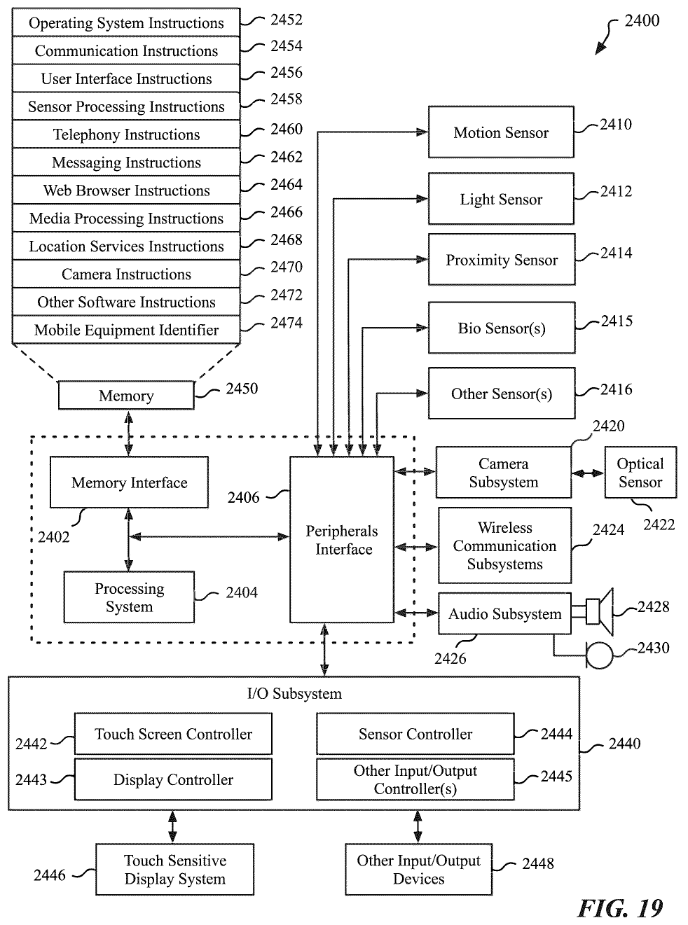

FIG. 19 is a block diagram of a device architecture 2400 for a mobile or embedded device, according to an embodiment. The device architecture 2400 includes a memory interface 2402, a processing system 2404 including one or more data processors, image processors and/or graphics processing units, and a peripherals interface 2406. The various components can be coupled by one or more communication buses or signal lines. The various components can be separate logical components or devices or can be integrated in one or more integrated circuits, such as in a system on a chip integrated circuit.

The memory interface 2402 can be coupled to memory 2450, which can include high-speed random-access memory such as static random-access memory (SRAM) or dynamic random-access memory (DRAM) and/or non-volatile memory, such as but not limited to flash memory (e.g., NAND flash, NOR flash, etc.).

Sensors, devices, and subsystems can be coupled to the peripherals interface 2406 to facilitate multiple functionalities. For example, a motion sensor 2410, a light sensor 2412, and a proximity sensor 2414 can be coupled to the peripherals interface 2406 to facilitate the mobile device functionality. One or more biometric sensor(s) 2415 may also be present, such as a fingerprint scanner for fingerprint recognition or an image sensor for facial recognition. Other sensors 2416 can also be connected to the peripherals interface 2406, such as a positioning system (e.g., GPS receiver), a temperature sensor, or other sensing device, to facilitate related functionalities. A camera subsystem 2420 and an optical sensor 2422, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 2424, which can include radio frequency receivers and transmitters and/or optical (e.g., infrared) receivers and transmitters. The specific design and implementation of the wireless communication subsystems 2424 can depend on the communication network(s) over which a mobile device is intended to operate. For example, a mobile device including the illustrated device architecture 2400 can include wireless communication subsystems 2424 designed to operate over a GSM network, a CDMA network, an LTE network, a Wi-Fi network, a Bluetooth network, or any other wireless network. In particular, the wireless communication subsystems 2424 can provide a communications mechanism over which a media playback application can retrieve resources from a remote media server or scheduled events from a remote calendar or event server.

An audio subsystem 2426 can be coupled to a speaker 2428 and a microphone 2430 to facilitate voice-enabled functions, such as voice recognition, voice replication, digital recording, and telephony functions. In smart media devices described herein, the audio subsystem 2426 can be a high-quality audio system including support for virtual surround sound.

The I/O subsystem 2440 can include a touch screen controller 2442 and/or other input controller(s) 2445. For computing devices including a display device, the touch screen controller 2442 can be coupled to a touch sensitive display system 2446 (e.g., touch-screen). The touch sensitive display system 2446 and touch screen controller 2442 can, for example, detect contact and movement and/or pressure using any of a plurality of touch and pressure sensing technologies, including but not limited to capacitive, resistive, infrared, and surface acoustic wave technologies, as well as other proximity sensor arrays or other elements for determining one or more points of contact with a touch sensitive display system 2446. Display output for the touch sensitive display system 2446 can be generated by a display controller 2443. In one embodiment, the display controller 2443 can provide frame data to the touch sensitive display system 2446 at a variable frame rate.

In one embodiment, a sensor controller 2444 is included to monitor, control, and/or processes data received from one or more of the motion sensor 2410, light sensor 2412, proximity sensor 2414, or other sensors 2416. The sensor controller 2444 can include logic to interpret sensor data to determine the occurrence of one of more motion events or activities by analysis of the sensor data from the sensors.

In one embodiment, the I/O subsystem 2440 includes other input controller(s) 2445 that can be coupled to other input/control devices 2448, such as one or more buttons, rocker switches, thumb-wheel, infrared port, USB port, and/or a pointer device such as a stylus, or control devices such as an up/down button for volume control of the speaker 2428 and/or the microphone 2430.

In one embodiment, the memory 2450 coupled to the memory interface 2402 can store instructions for an operating system 2452, including portable operating system interface (POSIX) compliant and non-compliant operating system or an embedded operating system. The operating system 2452 may include instructions for handling basic system services and for performing hardware dependent tasks. In some implementations, the operating system 2452 can be a kernel.

The memory 2450 can also store communication instructions 2454 to facilitate communicating with one or more additional devices, one or more computers and/or one or more servers, for example, to retrieve web resources from remote web servers. The memory 2450 can also include user interface instructions 2456, including graphical user interface instructions to facilitate graphic user interface processing.

Additionally, the memory 2450 can store sensor processing instructions 2458 to facilitate sensor-related processing and functions; telephony instructions 2460 to facilitate telephone-related processes and functions; messaging instructions 2462 to facilitate electronic-messaging related processes and functions; web browser instructions 2464 to facilitate web browsing-related processes and functions; media processing instructions 2466 to facilitate media processing-related processes and functions; location services instructions including GPS and/or navigation instructions 2468 and Wi-Fi based location instructions to facilitate location based functionality; camera instructions 2470 to facilitate camera-related processes and functions; and/or other software instructions 2472 to facilitate other processes and functions, e.g., security processes and functions, and processes and functions related to the systems. The memory 2450 may also store other software instructions such as web video instructions to facilitate web video-related processes and functions; and/or web shopping instructions to facilitate web shopping-related processes and functions. In some implementations, the media processing instructions 2466 are divided into audio processing instructions and video processing instructions to facilitate audio processing-related processes and functions and video processing-related processes and functions, respectively. A mobile equipment identifier, such as an International Mobile Equipment Identity (IMEI) 2474 or a similar hardware identifier can also be stored in memory 2450.

Each of the above identified instructions and applications can correspond to a set of instructions for performing one or more functions described above. These instructions need not be implemented as separate software programs, procedures, or modules. The memory 2450 can include additional instructions or fewer instructions. Furthermore, various functions may be implemented in hardware and/or in software, including in one or more signal processing and/or application specific integrated circuits.

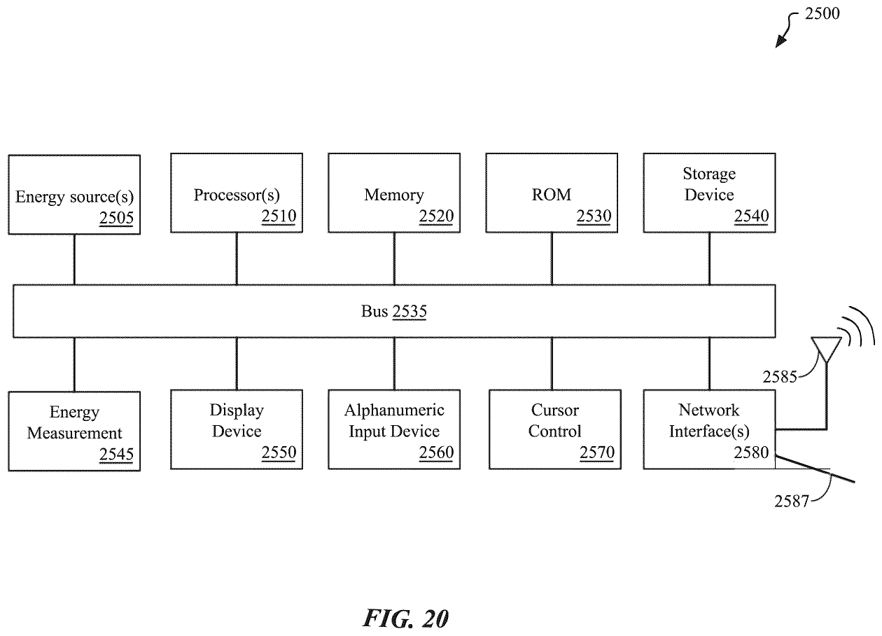

FIG. 20 is a block diagram of a computing system 2500, according to an embodiment. The illustrated computing system 2500 is intended to represent a range of computing systems (either wired or wireless) including, for example, desktop computer systems, laptop computer systems, tablet computer systems, cellular telephones, personal digital assistants (PDAs) including cellular-enabled PDAs, set top boxes, entertainment systems or other consumer electronic devices, smart appliance devices, or one or more implementations of a smart media playback device. Alternative computing systems may include more, fewer and/or different components. The computing system 2500 can be used to provide the computing device and/or a server device to which the computing device may connect.

The computing system 2500 includes bus 2535 or other communication device to communicate information, and processor(s) 2510 coupled to bus 2535 that may process information. While the computing system 2500 is illustrated with a single processor, the computing system 2500 may include multiple processors and/or co-processors. The computing system 2500 further may include memory 2520 in the form of random access memory (RAM) or other dynamic storage device coupled to the bus 2535. The memory 2520 may store information and instructions that may be executed by processor(s) 2510. The memory 2520 may also be main memory that is used to store temporary variables or other intermediate information during execution of instructions by the processor(s) 2510.

The computing system 2500 may also include read only memory (ROM) 2530 and/or another data storage device 2540 coupled to the bus 2535 that may store information and instructions for the processor(s) 2510. The data storage device 2540 can be or include a variety of storage devices, such as a flash memory device, a magnetic disk, or an optical disc and may be coupled to computing system 2500 via the bus 2535 or via a remote peripheral interface.

The computing system 2500 may also be coupled, via the bus 2535, to a display device 2550 to display information to a user. The computing system 2500 can also include an alphanumeric input device 2560, including alphanumeric and other keys, which may be coupled to bus 2535 to communicate information and command selections to processor(s) 2510. Another type of user input device includes a cursor control 2570 device, such as a touchpad, a mouse, a trackball, or cursor direction keys to communicate direction information and command selections to processor(s) 2510 and to control cursor movement on the display device 2550. The computing system 2500 may also receive user input from a remote device that is communicatively coupled via one or more network interface(s) 2580.

The computing system 2500 further may include one or more network interface(s) 2580 to provide access to a network, such as a local area network. The network interface(s) 2580 may include, for example, a wireless network interface having antenna 2585, which may represent one or more antenna(e). The computing system 2500 can include multiple wireless network interfaces such as a combination of Wi-Fi, Bluetooth®, near field communication (NFC), and/or cellular telephony interfaces. The network interface(s) 2580 may also include, for example, a wired network interface to communicate with remote devices via network cable 2587, which may be, for example, an Ethernet cable, a coaxial cable, a fiber optic cable, a serial cable, or a parallel cable.

In one embodiment, the network interface(s) 2580 may provide access to a local area network, for example, by conforming to IEEE 802.11 wireless standards and/or the wireless network interface may provide access to a personal area network, for example, by conforming to Bluetooth standards. Other wireless network interfaces and/or protocols can also be supported. In addition to, or instead of, communication via wireless LAN standards, network interface(s) 2580 may provide wireless communications using, for example, Time Division, Multiple Access (TDMA) protocols, Global System for Mobile Communications (GSM) protocols, Code Division, Multiple Access (CDMA) protocols, Long Term Evolution (LTE) protocols, and/or any other type of wireless communications protocol.

The computing system 2500 can further include one or more energy sources 2505 and one or more energy measurement systems 2545. Energy sources 2505 can include an AC/DC adapter coupled to an external power source, one or more batteries, one or more charge storage devices, a USB charger, or other energy source. Energy measurement systems include at least one voltage or amperage measuring device that can measure energy consumed by the computing system 2500 during a predetermined period of time. Additionally, one or more energy measurement systems can be included that measure, e.g., energy consumed by a display device, cooling subsystem, Wi-Fi subsystem, or other frequently used or high-energy consumption subsystem.

FIG. 21 is a flow diagram illustrating methods for use with device locator systems, according to an embodiment. A delegate device 504 may receive a share resource locator directly from an owner device 502 (or another sharee device) using any number of communication methods, third party server 536 (such as via a third-party application), and/or a delegate server 534. For example, the owner device 502 or sharee device may send the share resource locator in an electronic message, text message, via a QR code, via a third-party application, file synchronization services, word processing application, note-taking application, file transfer services, cloud-based storage, and/or any other form of communication the share resource locator.

In flow diagram 2200, device locator server 520 receives a share resource locator request from delegate device 504 to access a locator service accessible at a device locator server 520 for an accessory device 530 shared by owner device 502. The owner device 502 may enable the share, and receipt of the share resource locator request to access the share with the share resource locator may begin the delegation. Continuing with the flow diagram 2100, the device locator server 520 may receive a share resource locator request to access a location service for an accessory device (2202). The delegate device 504 may access the share by sending a request to the device locator server 520 via an application with the share resource locator, such as selecting to access the share device locator by submitting a request with a web browser. In an embodiment, the delegate device 504 that is a sub-delegate of a delegate entity may access the share using the share resource locator with a third-party application via the third-party server 536.

The share resource locator includes a unique identifier that corresponds to an identifier for the share that may be looked up with the unique identifier and accessed via the device locator server 520. The share resource locator may resolve to a web page and/or web application to access the share. In an embodiment, a single share resource locator may be used to access the share by both a delegate device 504 for sub delegate of a delegate entity and/or a delegate device 504 (e.g., a sharee device) of a user unaffiliated with a delegate entity. The share resource locator may be shared to both users and delegate entities. In an embodiment, the share resource locator is a unique identifier for a resource (e.g., the address for a web page that may be used to access the share). In an embodiment, the share identifier corresponds to the share and delegate keys stored at the delegate server 534.

As indicated herein, the user of the owner device 502, via a delegation UI 503, can delegate all or a subset of device locator 520 services to the delegate entity via a transfer 505 of delegate keys to a share record established on the delegate server 534 for the delegate entity. The owner device 502 user can enable or disable the share at any time. Delegation can be performed by the owner device 502 by generating keys for one or more privacy windows expected for the duration and providing those keys to the delegate server 534 via the transfer 505 of delegate keys. The privacy window is a predefined period of time, such as M minutes, that a set of generated keys associated with the wireless accessory 530 are valid. In an embodiment, there is at least one new key for each privacy window. For example, if the duration of travel is expected to be an hour and the privacy window is 15 minutes, then the set of generated keys for the privacy window (e.g., 15 minutes) within the hour will include at least 4 keys. The delegate server 534 may store the delegate keys in a share record in a share database, and the delegate server 534 may encrypt and decrypt data exchanged with the device locator server 520 in response to requests by the delegate device 504.

The share resource locator may also include a cryptographic key and/or a delegate shared secret to generate a cryptographic key. The cryptographic key may be used by the delegate device 504 to encrypt/decrypt data received in response to requests for device locator services and/or the owner device 502. In some embodiments, the delegate device 504 associated with a delegate entity (e.g., a sub-delegate) may obtain the delegate shared secrets and/or cryptographic key from a third-party server. The delegate entity as a trusted entity to the owner device 502 may receive the delegate shared secret and/or cryptographic keys via the third-party application and store the delegate shared secret and/or cryptographic keys at the third-party server 536. The delegate entity may determine whether delegate shared secrets and/or cryptographic keys are shared directly with a sub-delegate device of a delegate entity or used to decrypt location information within third party application.

In one embodiment, the share resource locator may be implemented as a uniform resource locator (URL) and the delegate device 504 may access the share of the locator services using the share resource locator with an application, such as a web browser, web application, or a third-party application. Some embodiments may include the shared secret and/or cryptographic key in a portion of the share resource locator string that is only accessed within an application (e.g., a web browser) on the delegate device 504 and the shared secret and/or cryptographic key is not sent with a request to the device locator server 520 with the share resource locator. In this way, the location information may not be shared with the device locator services provider. In some embodiments, the cryptographic key may only be accessed within the application on the delegate device 504 when the request is sent to device locator server 520 (either directly or via the delegate server 534) and a response is received from the device locator server 520 and/or the delegate server 534. For example, the portion of the share resource locator string may be implemented as an anchor link in a uniform resource locator and the anchor link including the cryptographic key may only be accessed within the browser. By way of further example, a URL may be as follows:
“shareurl.com?parameter=1 #cryptographickey”,

where “shareurl.com” is the address/identifier for the resource, “parameter” is a parameter with a value assigned as 1, and the anchor link follows with “cryptographickey.” In another embodiment, a short form URL may be generated for the share resource locator and sent to the delegate device 504.

The device locator server 520 may receive the request directly from the delegate device 504, from the delegate server device 534, and/or a third-party server 536. The device locator server 520 may request and receive authentication credentials from the delegate device 504 (2204), and the device locator server 520 may attempt to authenticate the delegate device 504 with received authentication credentials. Authentication credentials may include multi-factor authentication types, passkeys, user identifiers and passwords, account identifiers and passwords, out-of-band verification methods (e.g., passcodes sent via messages, text, and/or electronic mail, etc.). In some embodiments, the delegate entity may authenticate the user (e.g., sub-delegate) and the third party server may provide credentials that indicate the delegate device 504 is authenticated.

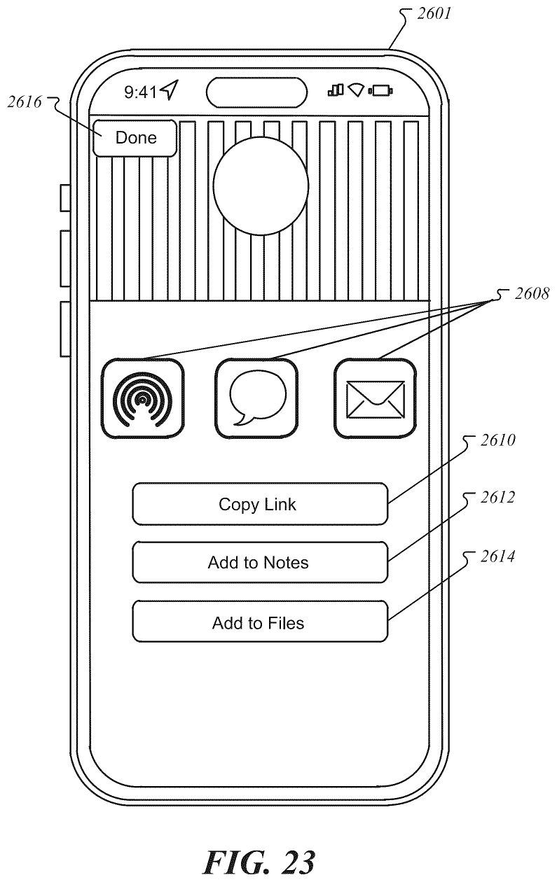

If the user of the delegate device 504 is authenticated, then a determination is made as to whether a rate-limit threshold for a number of sharee(s) or sharee request(s) has been exceeded. Rate-limit threshold checks and defined threshold number of user checks may be implemented using techniques to avoid providing user identifiers for the share to the device locator provider. In an embodiment, a hash function is applied to an identifier for the delegate user and/or delegate device to obfuscate the identifier yet allow for recording the share request by the user. The identifier for the delegate user or delegate device may be an account identifier, a device identifier, and/or a phone number, etc. to produce a hash result with the hash function. A comparison is performed between the hash result and existing hash results associated with the share resource locator stored in a database. The database is an organized collection of data. The hash result for the identifier associated with the delegate device 504 is compared to a set of hash results stored in a database associated with the share resource locator. If the comparison results in a match with an existing hash result stored in the database for the share resource locator, then the authenticated user has accessed the share previously and a number of users to the share does not need to be increased. FIG. 23 illustrates in a user interface element 2604 a summary of the number or unique users (based on identifiers) to the share. The number of access requests of the share may optionally be recorded. Alternatively, if the comparison does not result in a match, then the hash result is a unique hash result for the share and indicates it is a new user to the share and the number of visitors value is increased. A unique hash results for the identifier may be stored in association with a share locator resource in a record of the database and a number of unique hash result for the share resource locator may be incremented for each unique hash result to indicate the visit of a new user. If the number of unique hash results received for the resource locator request exceeds or is equal to a rate-limiting threshold value and/or a defined threshold number of permitted share requests, then the received share request may be denied. If the number of unique hash result does not exceed a rate limiting threshold and/or the defined threshold number of permitted share requests, then a unique hash result is added to the hash result database record associated with the share resource locator.

Continuing with the flow diagram, if the number of unique hash results received for the resource locator request does not exceed the rate-limiting threshold or the defined threshold, then metadata is evaluated to determine if conditions are satisfied for a share with the authenticated user of the delegate device (2206). The metadata defines a set of conditions for the share of the set of location services capabilities. In an embodiment, metadata on the owner device 502 associated with the delegate entity and/or selected by the user on the owner device 502 to associate with the share may define a set of conditions. The metadata may define time-bound limits for the share, an access policy for sharees participating in the share for the accessory device 530, and/or any other conditions for the share. The access policy for each sharee participating in a share of location services for the accessory device 530 is established when the sharee accepts a request to participate in the share. The access policy may define when, where, and who the sharee permits to be informed of their respective sharee device location. An authenticated user of the delegate device 504 associated with may access locator services 522 upon request after satisfying a set of conditions. The set of conditions may be established by the device owner and/or the delegate entity. The set of conditions may be for a state of the owner device 502, the status of the wireless accessory 530, the delegate device 504, and/or the authenticated user of the delegate device 504. The set of conditions may be time-based conditions, geo-based conditions, conditions based on status of the wireless accessory 530, and/or location of the owner device 502 or sharee of the owner device (e.g., 504).

In some embodiments, the metadata may identify the expected delegate role, the duration of the share, the expiration time of the share, access policies for location information, and/or any other conditions for a share. For example, the access policies established between sharees and/or owners participating the share may indicate time frames and/or accessory device status information in which access is permitted or denied. Continuing with the example, the access policy may indicate that an accessory device status of “near owner device” and/or “near sharee device” is not permitted. In an embodiment, the wireless accessory 530 is defined as near to a particular device when the particular device is either wirelessly or physically connected to the wireless accessory 530. In another embodiment, the wireless accessory 530 is defined as near to a particular device (owner device or sharee device) if the particular device is within range to receive a beacon signal range from the wireless accessory 530. For example, the owner device 534 is near to the wireless accessory if the owner device 534 is either wirelessly connected or physically connected to the wireless accessory 530. In another example, a delegate of the delegate entity may send information on the location of the accessory device and designate the accessory device as near the owner device. For example, delegate or sub-delegate of the delegate entity may hand the accessory device 530 back to the owner and designate the accessory device as with the owner device and designate the accessory device 530 as near the owner.

Upon a determination that a set of conditions defined in metadata for the share are satisfied, a response for the location service access request is sent to the delegate device 504 (2208). The share resource locator includes the unique identifier that may be used to retrieve the share identifier associated with the share resource locator. The unique identifier may be used to look up and retrieve the share identifier to locate the share and/or corresponding delegate keys at the delegate server. The second share identifier may ensure that there is a level of indirection and the identifier within the resource locator is not the second identifier used to retrieve the share. The device locator server 530 fulfills the request with the delegate keys from the delegate server for the share and sends the encrypted location information to the delegate device 504 either directly 524, from a third-party server 536 via a third-party application, and/or from a delegate server 534. The delegate device 504 decrypts the location information using cryptographic keys generated with the delegate shared secrets within the browser or with third-party application.

Although specific examples have been provided throughout the description referring to a delegate device affiliated with a delegate entity, those with skill in the art will recognize that the delegate device can be a sharee device with a sharee that is not affiliated with a delegate entity.

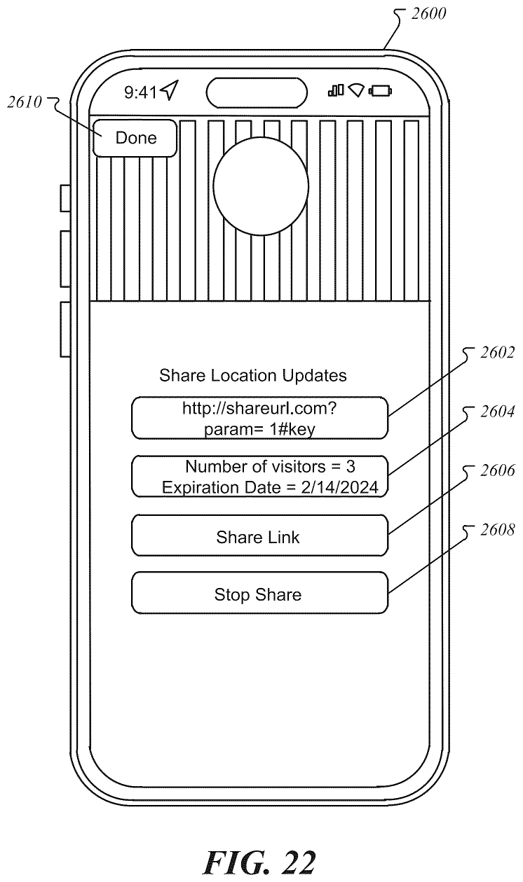

FIG. 22 illustrates an embodiment of a delegation user interface on electronic device 2600 that enables an owner device 502 (or a sharee device) and/or a delegate device 504 to share location updates. FIGS. 22 and 23 are variants of the delegation user interface 503 described herein. The share resource locator 2602 for the share is displayed within the share summary user interface entitled “Share Location Updates.” In some embodiments, the delegation user interface may be implemented as a web application that is executed within a browser. Embodiments may be implemented with an application server, such as delegate entity (e.g., third party server) web application server. Information on the share for the corresponding share resource locator 2302, as shown with “http://shareurl.com?param=1#key,” may be summarized within the user interface with a number of visitors, as shown with “Number of Visitors=3,” to the share and an expiration date, as shown with “Feb. 14, 2024,” 2604. User interface element “Share Link” 2606 allows the user to share a link using various communication methods as illustrated in an exemplary embodiment in FIG. 23. In an embodiment, the user enables the share by sending the share resource locator 2602. In another embodiment, the user is able to indicate in a setting whether to enable or disable the share corresponding to the share resource locator 2602. Alternatively, the user can disable the share with user interface element “Stop Share” 2608. User interface element 2610 allows the user to exit the web application, as shown with “Done.”

FIG. 23 illustrates an embodiment of a delegation user interface on electronic device 2601 that enables an owner device 502 (or a sharee device) and/or a delegate device 504 to share the share resource locator. As illustrated in the user interface on the electronic device 2601, the user may send the share resource locator 2602 with various communication methods 2608 as shown with icons for file transfer application, text messaging application, and electronic mail. Those with skill in the art will recognize that the user may use any type of communication method, such as text messages, electronic mail, file transfer services, cloud services, note-taking applications (as shown with 2612), word processing application, text editors, saved to files (as shown with 2614), and/or synchronization. The user may use electronic device 2601 copy and paste functionality with the share resource locator 2602, as illustrated with user interface element 2610 “Copy Link.” User interface element 2610 allows the user to exit the web application, as shown with “Done.”

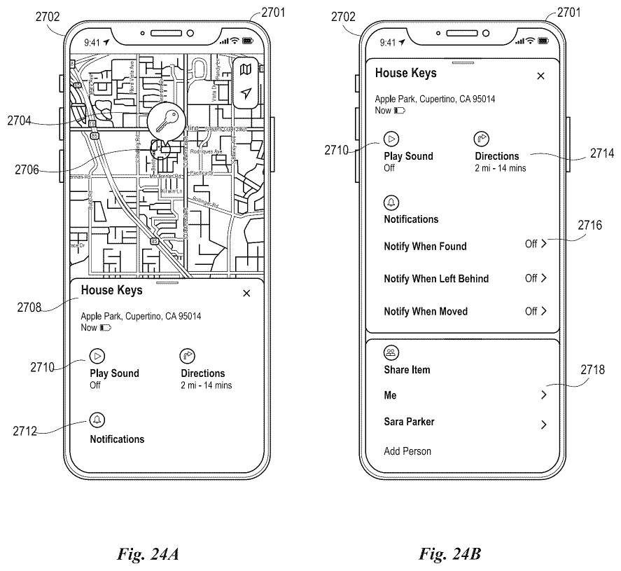

FIGS. 24A and 24B illustrate an exemplary embodiment of a delegation user interface on electronic device 2702. An authenticated delegate device 504 can access the device locator services with the share resource locator as illustrated with FIGS. 24A and 24B. FIGS. 24A and 24B are variants of Delegation UI 506 described herein. An error would be displayed if conditions were not met for the share of resource locator services, such as if the accessory device 530 was within beacon signal range of the owner device 502 or another delegate device 504. As shown in FIG. 24A, the device locator UI 2701 of a delegate device 504 can present a graphical user interface on electronic device 2702 with accessory device location 2704 for an accessory device associated with an item 2708 “House Keys” and location information is presented as shown with item “House Keys” located at 706 within a map. The owner and sharee have an access policy in which the sharee is permitted to have location information for the item associated with accessory device 530 when the item has a device status of located not near the owner as illustrated. The delegate device 530 has device locator capabilities of “Play sound” 2710 and “Notifications” 2712 (provided in more detail in 2716 of FIG. 24B. As shown in FIG. 24B, the device locator UI 2701 of a delegate device 504 can present a graphical user interface on electronic device 2702 with accessory device location 2704 and the delegate designated as “Me” 2718 has device locator capabilities of “Play sound” 2710, “Notifications”2 712 (e.g., “Notify When Found,” “Notify When Left Behind,” “Notify When Moved”), and “Share Item” by selecting an affordance to “Add Person.” As shown in FIG. 24B, the sharee “Me” 2718 is viewing share information on “House Keys” that is also shared with delegate “Sara Parker.”

Although the embodiments have been described in language specific to structural features and/or methodological acts, it is to be understood that the appended claims are not necessarily limited to the specific features or acts described. The specific features and acts disclosed are instead to be understood as embodiments of the claims useful for illustration.

What is claimed is:

1. A method for managing delegation of location services, the method comprising:
receiving, at a delegate server from a delegate device, authentication credentials for a sub-delegate of a delegate entity;
determining at least one locator service for an accessory device, the at least one locator service accessible to the delegate device with the received authentication credentials;
receiving, from the delegate device, a request for the at least one locator service;
evaluating a set of inputs to determine if a set of conditions corresponding to the at least one locator service and the delegate device are satisfied;
upon determination that the set of conditions are satisfied, sending the request for the at least one locator service to a device locator server; and
decrypting a response to the request received from the device locator server using one or more encryption keys stored for the delegate entity.

2. The method of claim 1, the method further comprising:
sending, to the delegate device, a set of locator services permitted with a role for the subdelegate with the received authentication credentials.

3. The method of claim 1, wherein at least one condition from the set of conditions is that the sub-delegate is associated with the delegate entity.

4. The method of claim 1, wherein at least one condition from the set of conditions is that the accessory device status is not at least one of a near owner status or a near sharee status.

5. The method of claim 4, wherein the near owner status includes that the owner device is within beacon signal range of the accessory device.

6. The method of claim 1, further comprising:
sending, to the delegate device, the response to the request, wherein the response is encrypted with a cryptographic key generated with a shared secret between the delegate device and a device paired with the accessory device.

7. A method for delegating location services for an accessory device, the method comprising:
determining, at an electronic device, a set of delegate keys for one or more privacy periods for the accessory device, the one or more privacy periods correspond to a defined period of time for a share of one or more locator services with a delegate entity;
sending, to a delegate server, a request to add the set of delegate keys to the share;
sending, to the delegate server, metadata associated with a delegate entity, the metadata indicating an event with the delegate entity; and
receiving location information for the accessory device and displaying the location information with the metadata associated with the delegate entity.

8. The method of claim 7, further comprising:
sending, to the delegate server, a set of conditions for the delegate entity to access the set of locator services for the accessory device.

9. The method of claim 7, further comprising:
sending, to the delegate server, a set of locator services accessible by sub-delegates of the delegate entity.

10. The method of claim 7, wherein the metadata includes a set of locator services for the accessory device and information on the defined period of time for the share of one or more locator services.

11. The method of claim 7, wherein the set of conditions are provided by the delegate entity.

12. The method of claim 7, further comprising:
sending, to a delegate device, at least one shared secret to generate cryptographic keys.

13. The method of claim 7, further comprising:
sending, to the delegate device, the set of delegate keys and the metadata.

14. The method of claim 7, wherein the delegate device and the electronic device communicate via near field communication, Bluetooth Low Energy, or other radio protocol.

15. The method of claim 7, wherein the electronic device is associated with an online account for an owner device paired to the accessory device.

16. The method of claim 15, wherein the electronic device is selected from a set of electronic devices associated with trusted online accounts, wherein the trusted online accounts received shared secrets from an owner device to generate delegate keys, wherein the owner device is paired to the accessory device.

17. A method for a delegate device for accessing location services for an accessory device, the method comprising:
sending, to a delegate server, authentication credentials for a sub-delegate of a delegate entity and information on at least one condition for accessing location services for an accessory device;
receiving information on a set of location services accessible for the authentication credentials satisfying the at least one condition;
sending, to a delegate server, a request for locator services for the accessory device; and
receiving an encrypted response for the request.

18. The method of claim 17, further comprising:
receiving, from an electronic device, a set of delegate keys and metadata, the metadata indicating an event with the delegate entity.

19. The method of claim 17, further comprising:
receiving, from an electronic device, a delegate shared secret; and
decrypting the encrypted response with decryption keys generated in part using the delegate shared secret.

20. The method of claim 17, wherein the at least one condition for accessing location services is determined based on the sub-delegate role at the delegate entity.

21. The method of claim 17, wherein satisfying the at least one condition comprises:
sending, to the delegate server, location information for the delegate device; and
receiving an indication that the delegate device with the authenticated credentials for the sub-delegate role is located in at least one delegate entity location authorized for the request.

22. The method of claim 17, further comprising:
detecting, from the accessory device, a beacon signal; and
transmitting location information for the accessory device to at least one of an owner device or a location server.

23. The method of claim 22, wherein the location information is encrypted using encryption keys generated using at least a shared secret between the delegate device and a device paired with the accessory device.

24. A method for access of location services for a delegated accessory device, the method comprising:
receiving, at a delegate device, a share resource locator to access a location service for an accessory device, the share resource locator comprising a portion of the share resource locator accessible within an application on the delegate device, and the portion of the share resource locator comprising a cryptographic key;
sending, to a device locator server, a request to access the location service with the share resource locator via the application; and
decrypting a response to the request, from the device locator server, with the cryptographic key within the application.

25. The method of claim 24, wherein the share resource locator is a uniform resource locator and the portion of the uniform resource locator comprises an anchor link.

26. The method of claim 24, wherein the application is a third party application and the portion of the share resource locator is stored at a third party server.

27. A method for access of location services for a delegated accessory device, the method comprising:
receiving a share resource locator request to access a location service for an accessory device;
receiving, from a delegate device, authentication credentials;
evaluating metadata to determine if conditions are satisfied for a share with an authenticated user of the delegate device; and
upon a determination that a set of conditions are satisfied for a share, sending a response to the delegate device for the location service.

28. The method of claim 27, wherein the metadata includes an access policy and a rate-limit policy for the delegate entity.

29. The method of claim 27, further comprising:
applying a hash function to an identifier to produce a hash result for the identifier; and
comparing the hash result to a set of hash results associated with the share resource locator to determine if a rate limit threshold for the share is exceeded.

30. The method of claim 27, wherein evaluating metadata to determine if conditions satisfied comprises:
determining if the owner device is in beacon signal range of the accessory device.

31. The method of claim 27, wherein evaluating metadata to determine if conditions satisfied comprises:
determining if the delegate device associated with a delegate entity designated the accessory device as near an owner device.

32. The method of claim 27, further comprising:
receiving, at a third-party server, a share resource locator request via a third-party application to access a location service for the accessory device.
